(19) United States
(12) Patent Application Publication
(10) Pub. No.: US 2026/0322006 A1
(43) Pub. Date: Oct. 15, 2026

(54) CONNECTION ASSEMBLY, ADAPTER CONNECTOR, AND ELECTRONIC DEVICE

(71) Applicant: DONGGUAN LEADER PRECISION INDUSTRY CO., LTD., Dongguan City (CN)

(72) Inventors: Xunxu ZHANG, Dongguan City (CN); Xiaoqing ZHANG, Dongguan City (CN); Hongqiang XU, Dongguan City (CN)

(73) Assignee: DONGGUAN LEADER PRECISION INDUSTRY CO., LTD., Dongguan City (CN)

(21) Appl. No.: 19/404,752

(22) Filed: Dec. 1, 2025

(30) Foreign Application Priority Data
Apr. 9, 2025 (CN) 202510443868.7
Aug. 13, 2025 (CN) 202521723009.5
Sep. 9, 2025 (CN) 202521943108.4

(51) Int. Cl. H01R 12/71; H01R 12/70; H01R 13/24; H01R 13/652; H01R 31/06

(52) U.S. Cl. CPC H01R 12/714; H01R 12/7052; H01R 12/7082; H01R 13/24; H01R 13/652; H01R 31/06; H01R 2201/06

(57) ABSTRACT

The present application relates to a connection assembly, an adapter connector, and an electronic device. The connection assembly includes a first connector and a second connector, where the first connector includes at least one first terminal, the first terminal has an abutting segment, and the abutting segment extends in a first direction; and the second connector includes at least one second terminal, the second terminal is provided with an elastic contact portion at one end, and the elastic contact portion abuts against the abutting segment. The abutting segment forms an adjustable contact zone in the first direction, and the contact zone abuts against the elastic contact portion, so that the second connector at different positions in the first direction can be adapted to the abutting segment of the first connector.

### CROSS-REFERENCE TO RELATED APPLICATIONS

The present application claims all the benefits of the Chinese Utility Model Application No. 202521943108.4, filed on September 9, 2025 before the China National Intellectual Property Administration of the People’s Republic of China, entitled “Connection assembly and electronic device”, and the Chinese Utility Model Application No. 202521723009.5, filed on August 13, 2025 before the China National Intellectual Property Administration of the People’s Republic of China, entitled “Adapter connector and connection assembly,” and the Chinese Patent Application No. 202510443868.7, filed on April 9, 2025 before the China National Intellectual Property Administration of the People’s Republic of China, entitled “Connection module and electronic device”. The entire contents of all the aforementioned applications are explicitly incorporated herein by reference.

### FIELD

The present application relates to the technical field of electronic signal transmission, and in particular, to a connection assembly, an adapter connector, and an electronic device.

### BACKGROUND

In an electronic device, a connector with a data transmission interface is often arranged inside a product shell to transmit electronic signals.

### SUMMARY

The present application provides a connection assembly, an adapter connector, and an electronic device.

In a first aspect, the present application provides a connection assembly, including:
a first connector, where the first connector includes at least one first terminal, the first terminal has an abutting segment, and the abutting segment extends in a first direction; and
a second connector, where the second connector includes at least one second terminal, the second terminal is provided with an elastic contact portion, the elastic contact portion abuts against the abutting segment, the abutting segment forms an adjustable contact zone in the first direction, the contact zone abuts against the elastic contact portion, and the second connector is at a different position relative to the first connector in the first direction.

In a second aspect, the present application provides an electronic device, including the connection assembly provided in the first aspect of the present application.

In a third aspect, the present application provides an adapter connector, including:
a first terminal unit, where the first terminal unit includes a plurality of first terminals arranged side by side, and the first terminal includes a first connecting portion, a first bent portion, and a second connecting portion connected in sequence; and
a second terminal unit, where the second terminal unit includes a plurality of second terminals arranged side by side, and the second terminal includes a third connecting portion, a second bent portion, and a fourth connecting portion connected in sequence;
where the first terminal unit and the second terminal unit are sequentially arranged in a first direction, and both the first connecting portion and the third connecting portion extend in the first direction; one end of the first bent portion is connected at an angle to an end, away from the third connecting portion, of the first connecting portion; one end of the second bent portion is connected at an angle to an end, away from the first connecting portion, of the third connecting portion; and an anti-crosstalk space is formed between the first bent portion and the second bent portion.

In a fourth aspect, the present application provides a connector assembly, including the adapter connector as described in any item of the third aspect, and further including an interface connector, where a tail end of the interface connector is provided with a third terminal unit and a fourth terminal unit arranged in sequence in the first direction;
the third terminal unit includes a plurality of third terminals arranged side by side, the third terminal includes a first elastic portion facing the first terminal, and the first elastic portion elastically abuts against the first connecting portion; and
the fourth terminal unit includes a plurality of fourth terminals arranged side by side, the fourth terminal includes a second elastic portion facing the second terminal, and the second elastic portion elastically abuts against the third connecting portion.

In a fifth aspect, the present application further provides a connector assembly, including:
an interface connector, where the interface connector includes a first insulating body and a plurality of interface terminals, the plurality of interface terminals are arranged in the first insulating body, the interface terminal includes a mating portion and an elastic abutting portion, the mating portion is arranged at a front end of the interface terminal, and the elastic abutting portion is arranged at a tail end of the interface terminal; and
an adapter connector, where the adapter connector includes a second insulating body and a plurality of adapter terminals, the plurality of adapter terminals are arranged in the second insulating body, a front end of the adapter terminal is provided with a conductive portion extending in a first direction, and the plurality of conductive portions are arranged in one-to-one contact with the plurality of elastic abutting portions;
where the first insulating body is provided with a first limit portion extending in the first direction at an end facing the second insulating body, the second insulating body is provided with a second limit portion extending in the first direction at an end facing the first insulating body, the first limit portion and the second limit portion cooperate with each other, and the first limit portion is slidably connected to the second limit portion in the first direction.

In a sixth aspect, the present application further provides an electronic device, including the connector assembly as described in any item of the fifth aspect, and further including a shell, where the shell is provided with a first installation surface and a second installation surface, and the first installation surface and the second installation surface are at a preset distance; and
the interface connector is arranged on the first installation surface, and the adapter connector is arranged on the second installation surface.

Compared to the prior art, the above technical solutions provided in the embodiments of the present application have the following advantages:

The connection assembly according to the embodiments of the present application includes the first connector and the second connector, where the first connector includes the first terminal, the first terminal has the abutting segment extending in the first direction, the second connector includes the second terminal, the second terminal has the elastic contact portion, the elastic contact portion abuts against the abutting segment, the abutting segment forms the adjustable contact zone in the first direction, and the contact zone abuts against the elastic contact portion, so that the second connector at different positions in the first direction can be adapted to the abutting segment of the first connector. The elastic contact portion abuts against the abutting segment, achieving an electrical connection between the second terminal and the first terminal through elastic abutment without welding or other operations, and simplifying a connection process for the first terminal and the second terminal. The universality of the connection assembly is improved, thereby improving product development efficiency and lowering product manufacturing costs.

The electronic device according to the embodiments of the present application includes the foregoing connection assembly, where the connection assembly can connect the first connector and the second connector at any position in the first direction. Therefore, the electronic device naturally has the technical effects of the connection assembly.

### BRIEF DESCRIPTION OF THE DRAWINGS

The accompanying drawings herein are incorporated into the description and constitute a portion of the description, show embodiments in accordance with the present application, and are used with the description to explain the principles of the present application.

In order to explain the technical solutions in the embodiments of the present application or in the prior art more clearly, the accompanying drawings required for use in the description of the embodiments or the prior art will be briefly introduced below. Apparently, for a person of ordinary skill in the art, other drawings may be derived from these drawings without any creative effort.

One or more embodiments are exemplified by the corresponding drawings. The exemplified descriptions do not constitute limitations on the embodiments. The elements with the same reference numerals in the drawings are denoted as similar elements. Unless otherwise stated, the drawings do not constitute proportional limitations.

FIG. 1 is a first schematic structural diagram of a connection assembly according to an embodiment of the present application;

FIG. 2 is an exploded view of a connection assembly according to an embodiment of the present application;

FIG. 3 is a schematic structural diagram of a first connector according to an embodiment of the present application;

FIG. 4 is a schematic structural diagram of a second connector according to an embodiment of the present application;

FIG. 5 is an enlarged detail view of part A in FIG. 4 according to an embodiment of the present application;

FIG. 6 is a schematic diagram showing cooperation between first terminals and second terminals according to an embodiment of the present application;

FIG. 7 is a second schematic structural diagram of a connection assembly according to an embodiment of the present application;

FIG. 8 is an enlarged detail view of part B in FIG. 7 according to an embodiment of the present application;

FIG. 9 is a top view of a connection assembly according to an embodiment of the present application;

FIG. 10 is a cross-sectional view taken along line C-C in FIG. 9 according to an embodiment of the present application;

FIG. 11 is an enlarged detail view of part F in FIG. 10 according to an embodiment of the present application;

FIG. 12 is a third schematic structural diagram of a connection assembly according to an embodiment of the present application;

FIG. 13 is a cross-sectional view of the connection assembly in FIG. 12 according to an embodiment of the present application;

FIG. 14 is a cross-sectional view taken along line D-D in FIG. 9 according to an embodiment of the present application;

FIG. 15 is a cross-sectional view taken along line E-E in FIG. 9 according to an embodiment of the present application;

FIG. 16 is a schematic structural diagram of a shell according to an embodiment of the present application;

FIG. 17 is a partial external schematic diagram of an electronic device according to an embodiment of the present application;

FIG. 18 is a schematic structural diagram of an adapter connector according to an embodiment of the present application;

FIG. 19 is a front view of an adapter connector according to an embodiment of the present application;

FIG. 20 is a cross-sectional view taken along line A-A in FIG. 19 according to an embodiment of the present application;

FIG. 21 is a schematic structural diagram of a first terminal unit and a second terminal unit according to an embodiment of the present application;

FIG. 22 is a schematic diagram of arrangement of a first terminal and a second terminal according to an embodiment of the present application;

FIG. 23 is a schematic structural diagram of a connector assembly according to an embodiment of the present application;

FIG. 24 is a schematic structural diagram of an interface connector according to an embodiment of the present application;

FIG. 25 is an enlarged detail view of part B in FIG. 24 according to an embodiment of the present application;

FIG. 26 is a top view of a connector assembly according to an embodiment of the present application;

FIG. 27 is a cross-sectional view taken along line C-C in FIG. 26 according to an embodiment of the present application; and

FIG. 28 is an enlarged detail view of part D in FIG. 26 according to an embodiment of the present application;

FIG. 29 is a schematic structural diagram of a circuit board according to an embodiment of the present application;

FIG. 30 is a partial structural diagram of an electronic device according to an embodiment of the present application;

FIG. 31 is a cross-sectional view of a connector assembly according to an embodiment of the present application;

FIG. 32 is a schematic diagram of terminal connection of a connector assembly according to an embodiment of the present application;

FIG. 33 is an enlarged detail view of part A in FIG. 32 according to an embodiment of the present application;

FIG. 34 is an enlarged detail view of part B in FIG. 32 according to an embodiment of the present application;

FIG. 35 is a schematic structural diagram of an interface connector according to an embodiment of the present application;

FIG. 36 is a schematic structural diagram of an adapter connector according to an embodiment of the present application;

FIG. 37 is a top view of FIG. 30 according to an embodiment of the present application;

FIG. 38 is an enlarged detail view of part C in FIG. 37 according to an embodiment of the present application (i.e., a first schematic diagram showing cooperation between a first limit portion and a second limit portion);

FIG. 39 is a second schematic diagram showing cooperation between a first limit portion and a second limit portion according to an embodiment of the present application;

FIG. 40 is a third schematic diagram showing cooperation between a first limit portion and a second limit portion according to an embodiment of the present application;

FIG. 41 is a fourth schematic diagram showing cooperation between a first limit portion and a second limit portion according to an embodiment of the present application;

FIG. 42 is a first partial structural diagram of an interface connector according to an embodiment of the present application; and

FIG. 43 is a second partial structural diagram of an interface connector according to an embodiment of the present application.

### EXPLANATION OF REFERENCE NUMERALS

101. First connector; 1011. First terminal; 10111. Abutting segment; 10112. Positioning segment; 10113. First connecting segment; 10114. First limit segment; 1012. First insulating body; 10121. First positioning portion; 1013. Fifth positioning portion; 1014. Grounding member;

102. Second connector; 1021. Second terminal; 10211. Elastic contact portion; 102111. First bent segment; 102112. Second bent segment; 102113. Second limit segment; 10212. Second connecting segment; 1022. Second insulating body; 10221. Limit groove; 1023. Second connecting portion; 1024. Seventh positioning portion;

103. Shell; 1031. First installation surface; 1032. Second installation surface; 1033. Second positioning portion; 1034. Limit boss; 10341. Positioning surface; 10342. Guide surface; 1035. First connecting portion; 1036. Sixth positioning portion; 1037. Interface portion;

104. Circuit board; 1041. Third positioning portion; 1042. Fourth positioning portion; 1043. Grounding segment; 1044. Conductive portion;

201. First terminal; 2011. First connecting portion; 2012. First bent portion; 20121. First straight segment; 20122. First vertical segment; 2013. Second connecting portion;

202. Second terminal; 2021. Third connecting portion; 2022. Second bent portion; 20221. Second straight segment; 20222. Inclined segment; 20223. Third straight segment; 20224. Second vertical segment; 2023. Fourth connecting portion;

203. Anti-crosstalk space;

204. First insulating body; 2041. First clamping portion; 2042. First positioning portion;

205. Third terminal; 2051. First elastic portion; 2052, Fifth connecting portion;

206. Fourth terminal; 2061. Second elastic portion; 2062. Sixth connecting portion;

207. Second insulating body; 2071. Limit groove; 2072. Second clamping portion;

208. Circuit board; 2081. First conductive region; 2082. Second conductive region; 2083. Second positioning portion; 2084. Shell conductive portion;

209. Shell assembly; 2091. First shell; 2092. Second shell; 2093. Third shell;

301. Interface connector; 3011. First insulating body; 30111. First limit portion; 301111. Protrusion; 301112. Body portion; 30112. Insulating block; 30113. Insulating tongue plate; 301131. First surface; 301132. Second surface; 3012. Interface terminal; 30121. Mating portion; 30121a. First mating portion; 30121b. Second mating portion; 30122. Elastic abutting portion; 13. Shielding member;

302. Adapter connector; 3021. Second insulating body; 30211. Second limit portion; 3022. Adapter terminal; 30221. Conductive portion; 30222. Straight portion;

303. Circuit board; 3031. Connecting portion;

304. Shell; 3041. First installation surface; 3042. Second installation surface; 3043. Insertion hole.

### DETAILED DESCRIPTION

In order to make the objectives, technical solutions, and advantages of the embodiments of the present application clearer, the technical solutions in the embodiments of the present application will be described clearly and completely below in conjunction with the accompanying drawings therein. Apparently, the described embodiments are some of the embodiments of the present application, not all of them. Based on the embodiments of the present application, all other embodiments obtained by those of ordinary skill in the art without any creative effort shall fall within the scope of protection of the present application.

The following disclosure provides many different embodiments or examples to implement different structures of the present application. In order to simplify the disclosure of the present application, components and settings in specific examples are described below. Such components and settings are merely examples and are not intended to limit the scope of the present application. In addition, the present application may repeat reference numerals and/or letters in different examples. The repetition is for the purpose of simplification and clarity, and does not indicate the relationship between various discussed embodiments and/or settings.

For ease of description, spatial relative relationship terms can be used herein to describe the relative position or motion of one element or feature shown in the figures relative to the other element or feature. These relative relationship terms include "internal", "external", "inner", "outer", "below", "under", "on", "above", "front", "rear", etc. The spatial relative relationship terms are intended to include different orientations of an apparatus in use or operation, in addition to the orientations depicted in the figures. For example, if the apparatus in the figures undergoes a position flip, posture change, or motion state change, these directional indications also change accordingly. For example, one element described as "below the other element or feature" or "under the other element or feature" will subsequently be oriented as "on the other element or feature" or "above the other element or feature". Therefore, the exemplary term "under" may include both upper and lower orientations. The apparatus can be oriented otherwise (rotated 90 degrees or in other directions) and the spatial relative relationship descriptors used herein are explained accordingly.

In order to solve the technical problems of low product development efficiency and increased product manufacturing costs caused by low universality of connector assembly methods in the prior art, the present application provides a connection assembly and an electronic device, where an abutting segment 10111 of a first connector 101 can provide an adjustable contact zone for a second connector 102 in a first direction, so that the second connector 102, if its position changes in the first direction, can be connected to the first connector 101 through their elastic abutment, thereby reducing assembly difficulty, improving the universality of the connection assembly, improving product development efficiency, and lowering product manufacturing costs.

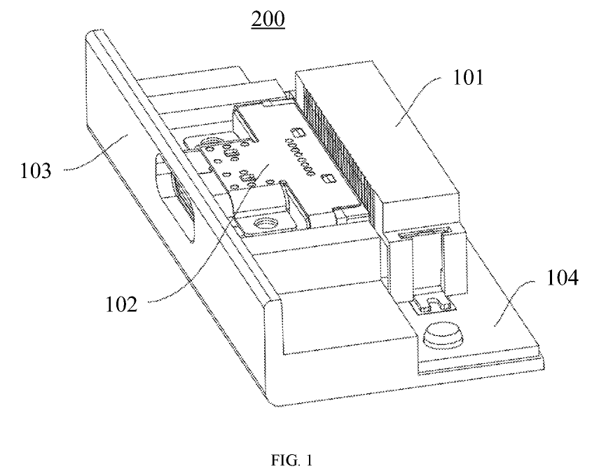

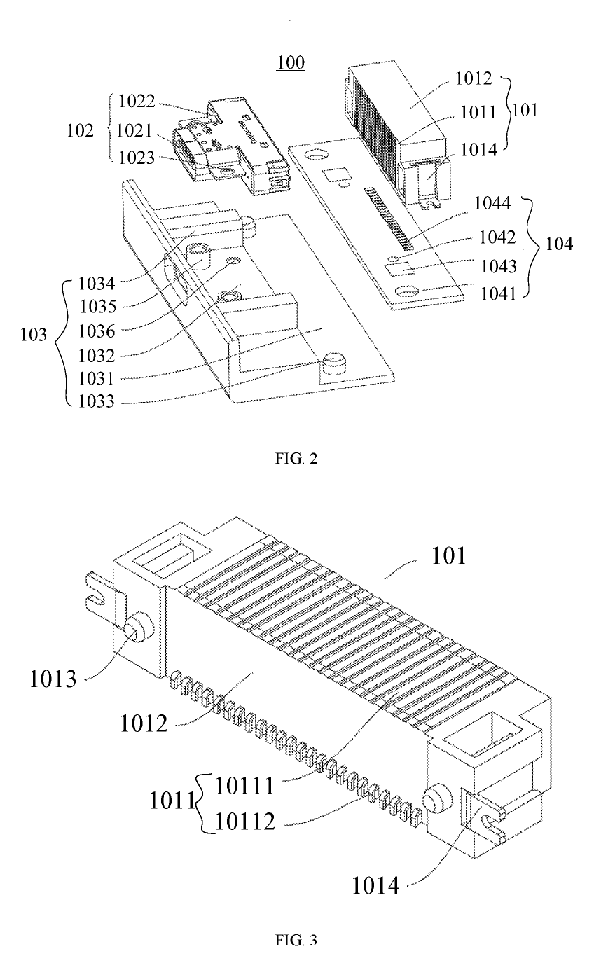

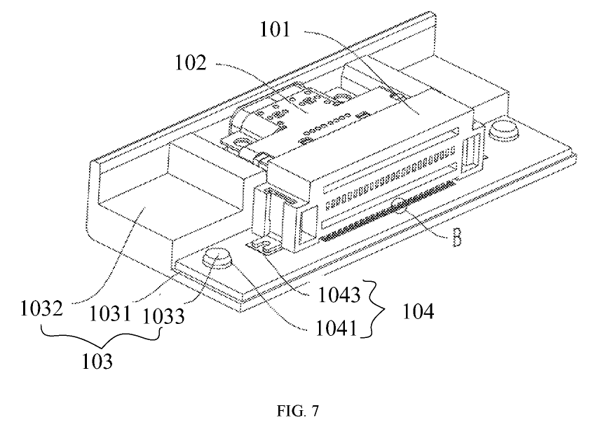

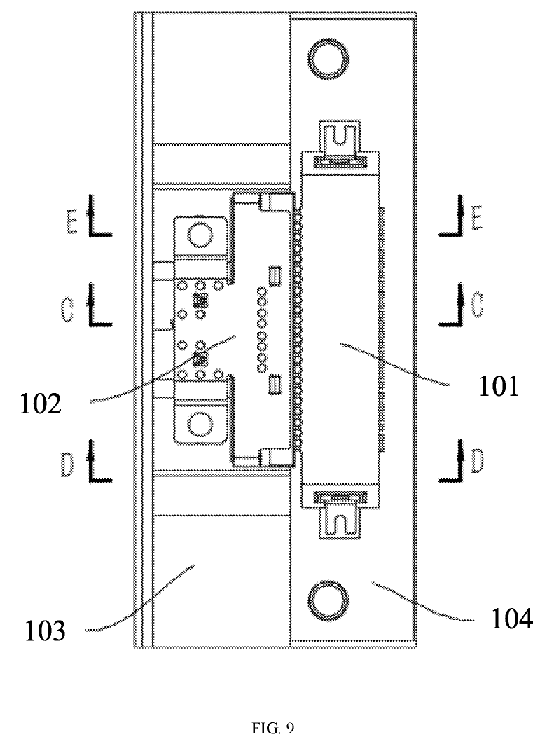

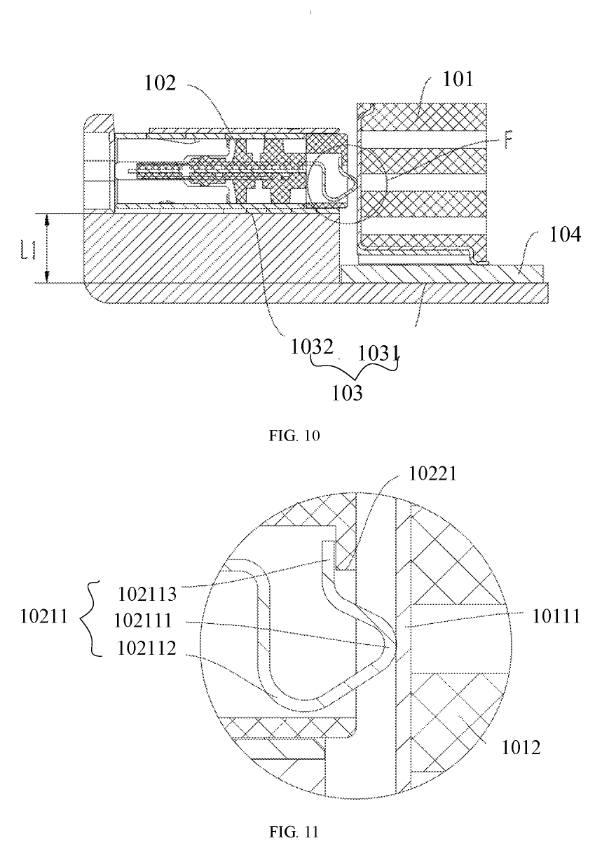

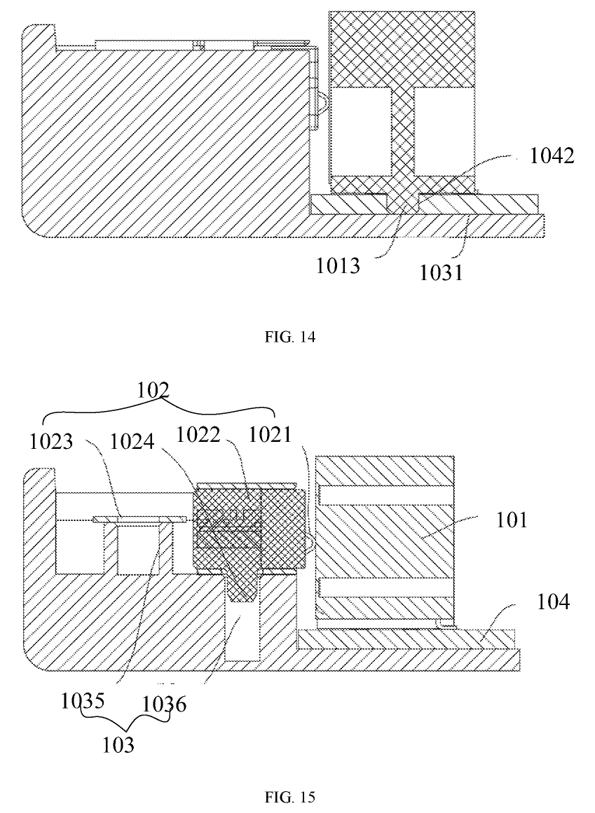

With reference to FIGS. 1 to 17, an embodiment of the present application provides a connection assembly 100, including a first connector 101 and a second connector 102, as shown in FIGS. 1 and 2. The first connector 101 may be used to connect with a circuit board 104 or other signal cables; the second connector 102 may have a data transmission interface, and its installation position may be designed according to the position of the interface, as shown in FIGS. 7, 10, 12, and 13.

The first connector 1 includes at least one first terminal 1011, the first terminal 1011 has an abutting segment 10111, and the abutting segment 10111 extends in the first direction, as shown in FIGS. 1, 6, 10, and 13. The abutting segment 10111 forms an adjustable contact zone in the first direction, and the contact zone is used for signal connection with the second connector 2, so that the second connector 102 at different positions in the first direction can be adapted to the abutting segment 10111 of the first connector 1.

The second connector 102 includes at least one second terminal 1021, the second terminal 1021 is provided with an elastic contact portion 10211, and the elastic contact portion 10211 abuts against the abutting segment 10111. The elastic abutment can achieve an electrical connection between the second terminal 1021 and the first terminal 1011 without welding or other operations, thereby simplifying a connection process for the first terminal 1011 and the second terminal 1021.

In addition, since the elastic contact portion 10211 of the second terminal 1021 abuts against the abutting segment 10111, surface mounting technology (SMT) processes and manpower input during assembly can be reduced, thereby improving production efficiency without worrying about product deformation after being treated in a high-temperature furnace.

It should be noted that the first direction may be a vertical direction or a horizontal direction. As long as the first direction is consistent with the installation position adjustment direction of the second connector 102 in the same series of products, the objective of the present application can be achieved. In the following embodiments, taking the height variation of an installation surface of the second connector 102 as an example for description, the first direction is the vertical direction.

In some embodiments of the present application, as shown in FIGS. 2, 3, 4, and 6, the first connector 101 includes a plurality of first terminals 1011, the second connector 102 includes a plurality of second terminals 1021, and the plurality of second terminals 1021 abut against the plurality of first terminals 1011 in one-to-one correspondence, ensuring a dedicated transmission channel for each signal, avoiding interference and confusion between signals, and improving the accuracy and reliability of signal transmission.

In some embodiments of the present application, as shown in FIGS. 2, 3, 9, 10, and 11, the first connector 101 further includes a first insulating body 1012, and a portion of the first terminal 1011 is embedded in the first insulating body 1012, achieving fixation of the first terminal 1011. The abutting segment 10111 is arranged on an edge, facing the second connector 2, of the first insulating body 1012, facilitating the abutment between the elastic contact portion 10211 and the abutting segment 10111 when the first connector 101 and the second connector 102 are arranged opposite.

It should be noted that the relative distance between the first connector 101 and the second connector 102 needs to meet a pre-loading requirement, that is, the elastic contact portion 10211 abuts against the abutting segment 10111 in a pre-loaded state, so that the elastic contact portion 10211 always have a tendency to move towards the abutting segment 10111 to restore deformation.

In some embodiments of the present application, as shown in FIGS. 3, 6, 7, and 8, the first insulating body 1012 includes a first positioning portion 10121, the first terminal 1011 has a positioning segment 10112, and the positioning segment 10112 is matched with the first positioning portion 10121. The positioning segment 10112 can be positioned, thereby facilitating accurate positioning connection between the first terminal 11 and the circuit board 4 or other signal cables through the positioning segment 112.

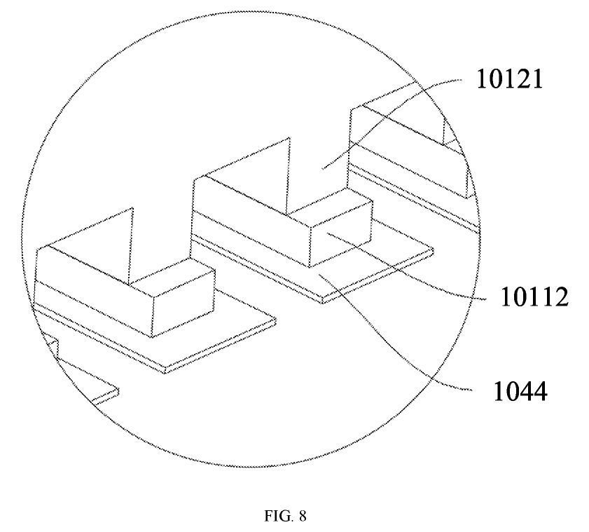

In some embodiments of the present application, as shown in FIGS. 7 and 8, when the quantity of first terminals 1011 is plural, the quantity of first positioning portions 10121 is also plural, thereby achieving the positioning of a plurality of positioning segments 10112. In order to reduce the manufacturing difficulty of the first positioning portions 10121, the plurality of first positioning portions 10121 and the first insulating body 1012 may be manufactured through an integral molding process.

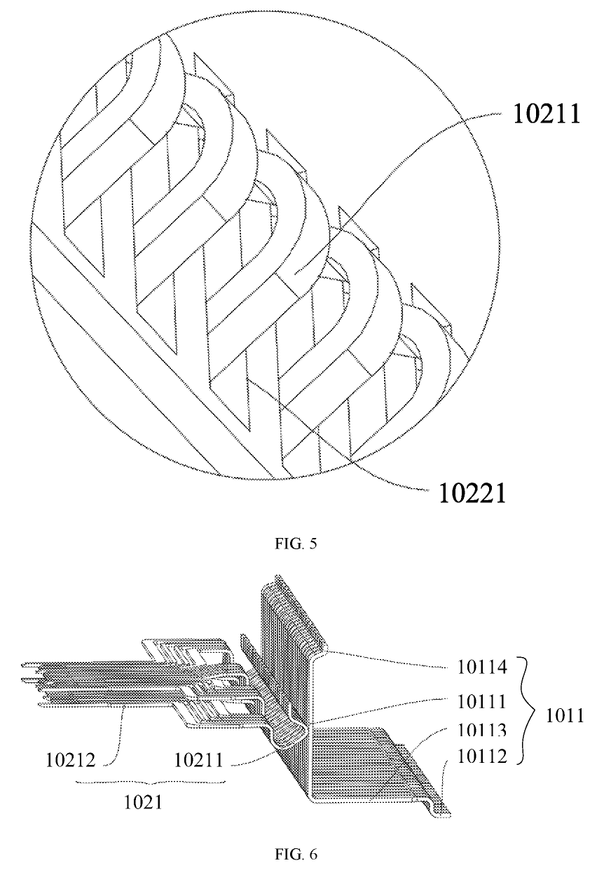

In some embodiments of the present application, as shown in FIG. 6, when the abutting segment 10111 and the positioning segment 10112 are arranged in different directions of the first connector 101, the connection between the abutting segment 10111 and the positioning segment 10112 may be implemented through a first connecting segment 10113, thereby facilitating the arrangement of the first terminal 1011 on the first connector 101.

In some embodiments of the present application, in order to avoid the disengagement of the abutting segment 10111 from the first insulating body 1012, a first limit segment 10114 is provided at a free end of the abutting segment 10111, and the first limit segment 10114 is embedded in the first insulating body 1012 to avoid the disengagement of the free end of the abutting segment 10111 from the first insulating body 1012, as shown in FIGS. 6, 10, and 13.

It should be noted that the first connector 101 may serve as an intermediate connector to achieve signal transmission between the second connector 102 and the circuit board 104 or other signal cables. The cooperating first connector 1 and second connector 2 can be connected at any position in the first direction (such as any height position). When the installation position of the second connector 102 and/or the first connector 1 changes, they can still be reliably connected through the elastic abutment between the elastic contact portion 10211 and the abutting segment 111 extending in the first direction, thereby preventing the signal transmission between the second connector 2 and the circuit board 4 or other cables from being limited by product panel structure adjustment.

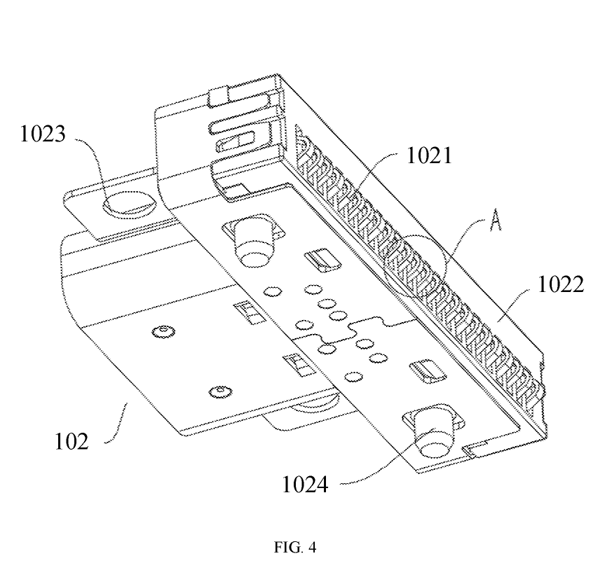

In some embodiments of the present application, as shown in FIGS. 4, 6, 10, and 11, the elastic contact portion 10211 is located at a tail end of the second terminal 1021, the elastic contact portion 10211 includes at least one bent segment, and the bent segment elastically abuts against the abutting segment 10111. The design of the bent segment enables the second terminal 1021 to have better elasticity and adaptability when abutting, thereby enhancing connection stability and reliability.

Meanwhile, the design of the bent segment may also play a role in dispersing stress. When the elastic contact portion 10211 is subjected to an external force from the abutting segment 10111, the bent segment can disperse stress to a larger region, thereby reducing the risk of stress concentration, extending the service life of the second terminal 1021, and improving the reliability of the second terminal 1021.

It should be noted that the elastic contact portion 10211 may be formed by connecting one or more bent segments, so that the elastic contact portion 10211 has deformation capability in a second direction (the second direction is not parallel to the first direction), that is, the elastic contact portion 10211 can abut against the abutting segment 10111 in the pre-loaded state. Such design can achieve the objective of the present application.

Further, the second direction is preferably perpendicular to the first direction. When the first direction is the vertical direction, the second direction is the horizontal direction, that is, the elastic contact portion 10211 and the abutting segment 10111 can be reliably connected through small pre-compression generated by the elastic contact portion 10211 in the horizontal direction, thereby reducing internal stress of the elastic contact portion 10211 and ensuring the service lives of the elastic contact portion 10211 and the second terminal 1021.

In some embodiments of the present application, as shown in FIGS. 4, 5, 10, and 11, the second connector 2 further includes a second insulating body 1022, and the second terminal 1021 is embedded in the second insulating body 1022, achieving the fixation of the second terminal 1021. The second insulating body 1022 is provided with a limit groove 10221, a portion of the elastic contact portion 10211 extends out of the limit groove 10221, whereby the elastic contact portion 10211 can be limited. When the elastic contact portion 10211 abuts against the abutting segment 10111, the elastic contact portion 10211 can be compressed or reset in the second direction under the guidance of groove walls on both sides of the limit groove 10221.

In some embodiments of the present application, as shown in FIGS. 4 and 5, when a plurality of second terminals 1021 are provided in the second connector 102, the second insulating body 1022 is correspondingly provided with a plurality of limit grooves 10221 to separate a plurality of elastic contact portions 10211, thereby avoiding electrical connection or crosstalk between the two adjacent elastic contact portions 10211 due to small spacing.

In some embodiments of the present application, as shown in FIGS. 6, 10, and 11, the elastic contact portion 10211 includes a second bent segment 102112, a first bent segment 102111, and a second limit segment 102113 connected in sequence, where the first bent segment 102111 abuts against the abutting segment 10111, and stress concentration at the abutting point of the elastic contact portion 10211 can be avoided through the first bent segment 102111; the second bent segment 102112 is connected between a second connecting segment 10212 and the first bent segment 102111, and the compression or deformation recovery of the elastic contact portion 10211 can be achieved through bending changes of the second bent segment 102112; and the second limit segment 102113 extends to an inner side of the limit groove 10221, whereby extension of a tail end of the elastic contact portion 10211 from the limit groove 10221 can be avoided.

In some embodiments of the present application, as shown in FIGS. 1, 2, 7, 10, 12, and 13, the connection assembly further includes a shell 103, the shell 103 includes a first installation surface 1031 and a second installation surface 1032, the first connector 101 is arranged on the first installation surface 1031, the second connector 102 is arranged on the second installation surface 1032, the first installation surface 1031 and the second installation surface 1032 are at a preset distance in the first direction, and the magnitude of the preset distance may be designed according to the preset position of the product interface. When the position of the second installation surface 1032 in the first direction changes due to interface position adjustment, the abutting position of the elastic contact portion 10211 of the second terminal 1021 on the abutting segment 10111 of the first terminal 1011 changes. In addition, the structures of other components do not need to be adjusted, which can improve product development efficiency and lower manufacturing costs.

In some embodiments of the present application, as shown in FIGS. 7, 9, and 10, when the preset distance between the first installation surface 1031 and the second installation surface 1032 is L1, the height difference between the first installation surface 1031 and the second installation surface 1032 in the vertical direction (i.e., the first direction) is large, and the elastic contact portion 10211 abuts against a middle segment of the abutting segment 111.

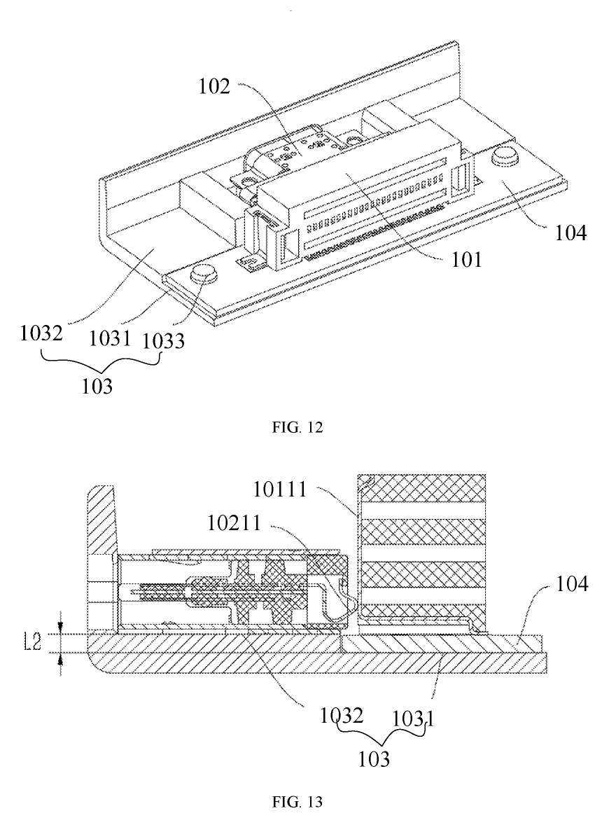

In other embodiments of the present application, as shown in FIGS. 12 and 13, when the height of the second installation surface 1032 in the first direction decreases due to product structure adjustment, the preset distance between the first installation surface 1031 and the second installation surface 1032 is L2, and L2<L1. At this point, the height difference between the first installation surface 1031 and the second installation surface 1032 in the vertical direction (i.e., the first direction) is small, and the elastic contact portion 10211 abuts against a lower segment of the abutting segment 10111.

In other embodiments of the present application, when the height of the second installation surface 1032 in the first direction increases due to product structure adjustment, the preset distance between the first installation surface 1031 and the second installation surface 1032 is L3, and L3>L1. At this point, the height difference between the first installation surface 1031 and the second installation surface 1032 in the vertical direction (i.e., the first direction) further increases, and the elastic contact portion 10211 abuts against an upper segment of the abutting segment 10111.

It should be noted that the extension length of the abutting segment 10111 in the first direction may be designed according to product design needs. As long as the extension length can cover a maximum height adjustment range of the same series of products, universality of the connection assembly in the series of products can be achieved. For example, in different products of the same series, when the preset distance between the second installation surface 1032 and the first installation surface 1031 includes 3.2 mm, 4.2 mm, 5.2 mm, and 6.2 mm, the extension distance (i.e., length) of the abutting segment 111 in the first direction should be at least more than 3 mm to cover the maximum height adjustment range of the series of products, thereby achieving the universality of the connection assembly in the series of products.

In some embodiments of the present application, as shown in FIGS. 1, 2, 7, and 8, the connection assembly further includes a circuit board 104, the circuit board 104 is arranged on the first installation surface 1031, and the first terminal 1011 is connected to the elastic contact portion 10211 and the circuit board 104 respectively, enabling signal transmission between the second connector 102, the first connector 101, and the circuit board 104. Meanwhile, compared to cable connections, the circuit board 104 can compactly integrate a plurality of electronic components together, which is beneficial to improving the integration of the system. Wires and circuits on the circuit board 104 form an efficient signal transmission network, ensuring accurate signal transmission.

In some embodiments of the present application, as shown in FIGS. 2, 7, and 12, the shell 103 includes a second positioning portion 1033, the second positioning portion 1033 is arranged on the first installation surface 1031, the circuit board 104 includes a third positioning portion 1041, and the third positioning portion 1041 is matched with the second positioning portion 1033, whereby assembly positioning of the circuit board 104 on the first installation surface 1031 can be achieved.

In some embodiments of the present application, as shown in FIGS. 2, 7, and 12, the second positioning portion 1033 and the third positioning portion 1041 are in concave-convex fit. One of the second positioning portion 1033 and the third positioning portion 1041 is a protruding positioning column or positioning block, and the other one is a recessed positioning hole or positioning groove. As long as their structures can achieve positioning assembly between the circuit board 104 and the shell 103, the objective of the present application can be achieved.

As a specific embodiment of the present application, as shown in FIGS. 7, 16, and 17, in order to avoid affecting the thickness or appearance of the shell 103 by designing the positioning hole or positioning groove on the first installation surface 1031, preferably, a positioning column (i.e., the second positioning portion 1033) is provided on an inner surface (i.e., the first installation surface 1031) of the shell 103, and a positioning hole (i.e., the third positioning portion 1041) matched with the positioning column is provided on the circuit board 104. Further, two ends of the circuit board 104 in a length direction are provided with the third positioning portions 1041, which can be used to achieve positioning connection between the two ends of the circuit board 104 and the shell 3, thereby improving the positioning accuracy between the circuit board 104 and the shell 103.

In some embodiments of the present application, as shown in FIGS. 1, 2, 7, and 8, the first connector 101 is arranged on the circuit board 104, the circuit board 4 is provided with a plurality of conductive portions 1044, and the positioning segments 10112 on the plurality of first terminals 1011 are crimped onto the plurality of conductive portions 1044 by the plurality of first positioning portions 10121, to achieve one-to-one corresponding connection between the plurality of positioning segments 10112 and the plurality of conductive portions 1044, thereby improving connection accuracy between the first connector 101 and the circuit board 104. The positioning segments 10112 and the conductive portions 1044 may be further welded to improve connection stability between the first terminals 1011 and the circuit board 104.

In some embodiments of the present application, as shown in FIGS. 2, 3, 9, and 14, the circuit board 104 is provided with a fourth positioning portion 1042, the first connector 101 is provided with a fifth positioning portion 1013, and the fifth positioning portion 1013 is matched with the fourth positioning portion 1042, whereby assembly positioning between the first connector 101 and the circuit board 104 can be achieved, and the plurality of positioning segments 10112 are correspondingly connected to the plurality of conductive portions 1044.

In some embodiments of the present application, as shown in FIGS. 2, 3, 9, and 14, the fourth positioning portion 1042 and the fifth positioning portion 1013 are in a concave-convex fit. One of the fourth positioning portion 1042 and the fifth positioning portion 1013 is a protruding positioning column or positioning block, and the other one is a recessed positioning hole or positioning groove. As long as their structures can achieve positioning assembly between the circuit board 4 and the first connector 101, the objective of the present application can be achieved.

In some embodiments of the present application, due to the stacked structure of the circuit board 104, it is not convenient to manufacture the protruding positioning structure. Preferably, the fourth positioning portion 1042 on the circuit board 104 is designed as a positioning hole, while the fifth positioning portion 1013 on the first connector 101 is designed as a positioning column, and the positioning column is integrally formed with the first insulating body 1012. The fifth positioning portion 1013 of the first connector 101 is embedded into the fourth positioning portion 1042 of the circuit board 104 to achieve precise positioning between the first connector 101 and the circuit board 104.

As a specific embodiment of the present application, as shown in FIGS. 2 and 3, the first connector 101 is provided with the fifth positioning portions 1013 on two sides at the bottom to achieve positioning connection between two sides of the first connector 101 and two sides of the circuit board 104, thereby improving the positioning accuracy between the first connector 101 and the circuit board 104.

In some embodiments of the present application, as shown in FIGS. 2, 3, 7, and 9, the first connector 101 is provided with grounding members 1014 at two ends, the circuit board 104 is provided with grounding portions 1043, and the grounding portions 1043 are correspondingly connected to the grounding members 1014, whereby not only can electrostatic interference and electromagnetic interference be prevented inside the connection assembly, but also the first connector 101 can be prevented from tilting through the connection of the grounding members 1014 at the two ends of the first connector 101 with the circuit board 104. Further, in order to improve the stability of connection between the grounding members 1014 and the grounding portions 1043, the grounding members 1014 and the grounding portions 1043 may be fixedly connected by welding or other operations.

In some embodiments of the present application, as shown in FIGS. 2, 7, 9, 12, and 16, the shell 103 further includes a limit boss 1034, the limit boss 1034 protrudes from the second installation surface 1032, and the limit boss 1034 abuts against an outer wall of the second connector 102 to achieve assembly positioning of the second connector 102 on the second installation surface 1032.

In some preferred embodiments of the present application, as shown in FIGS. 2, 7, 9, 12, and 16, two limit bosses 1034 are provided on the second installation surface 1032 and located on two sides of the second connector 102 to abut against the outer walls of the two sides of the second connector 102.

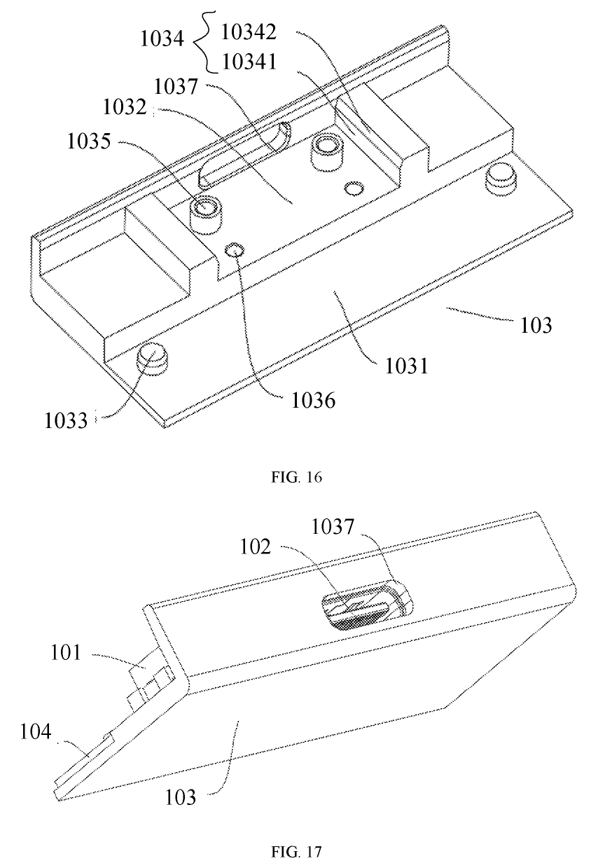

In some embodiments of the present application, as shown in FIG. 16, the limit boss 1034 includes a positioning surface 10341 and a guide surface 10342, where the positioning surface 10341 is used to abut against the outer wall of the second connector 102, and the guide surface 10342 is inclined to facilitate an operator to place the second connector 102 into a positioning space enclosed by the positioning surface 10341 and the second installation surface 1032.

In some embodiments of the present application, as shown in FIGS. 2, 4, 9, and 15, the shell 103 further includes a sixth positioning portion 1036, the sixth positioning portion 1036 is arranged on the second installation surface 1032, the second connector 2 includes a seventh positioning portion 1024, and the seventh positioning portion 1024 is matched with the sixth positioning portion 1036, whereby precise positioning between the second connector 102 and the shell 103 can be achieved, thereby ensuring accurate mating between the second connector 102 and the first connector 101.

In some embodiments of the present application, as shown in FIGS. 2, 4, 9, and 15, the sixth positioning portion 1036 and the seventh positioning portion 1024 are in a concave-convex fit. One of the sixth positioning portion 1036 and the seventh positioning portion 1024 is a protruding positioning column or positioning block, and the other one is a recessed positioning hole or positioning groove. As long as their structures can achieve positioning assembly between the shell 103 and the second connector 102, the objective of the present application can be achieved.

In some embodiments of the present application, as shown in FIGS. 2, 4, 9, and 15, the seventh positioning portion 1024 is a positioning column, and the positioning column is integrally formed with the second insulating body 1022, where the integral formation can avoid adverse effects on the terminal layout inside the second connector 102 when positioning holes or positioning grooves are provided on the second connector 102. The sixth positioning portion 1036 is a blind hole, and the blind hole is recessed on the second installation surface 1032, where the blind hole can achieve positioning connection between the second connector 102 and the second installation surface 1032, and can also avoid adverse effects on the appearance of the shell 103 due to the design of the sixth positioning portion 1036.

In some embodiments of the present application, as shown in FIGS. 2, 4, 9, 15, and 16, the shell 103 further includes a first connecting portion 1035, the first connecting portion 1035 is arranged on the second installation surface 1032, the second connector 102 includes a second connecting portion 1023, and the second connecting portion 1023 is correspondingly connected to the first connecting portion 1035, whereby the second connector 102 and the shell 103 can be fixedly connected, and displacement of the second connector 102 during use can be prevented from affecting the performance of an electronic device.

In some embodiments of the present application, as shown in FIGS. 2, 4, 9, 15, and 16, in order to facilitate maintenance and replacement of the second connector 102, the first connecting portion 1035 and the second connecting portion 1023 may be detachably connected through a threaded member or a clamping member.

As a specific embodiment of the present application, as shown in FIGS. 2, 4, 9, 15, and 16, the first connecting portion 1035 is a screw column, the screw column protrudes from the second installation surface 1032, the second connecting portion 1023 is a connecting plate, the connecting plate is arranged on both sides of the second connector 102, the connecting plate is provided with a through hole, and a screw may sequentially pass through the second connecting portion 1023 and the first connecting portion 1035 to fixedly connect the second connector 102 and the shell 103.

With reference to FIGS. 1 to 17, an embodiment of the present application provides a partial schematic diagram of an electronic device 200, including the connection assembly 100 described in the foregoing embodiments, where the shell 103 may serve as a housing or panel of the electronic device, and the second connector 102 may serve as a data transmission interface of the electronic device, as shown in FIG. 17. An external data transmission interface may extend into the shell 103 through an interface portion 1037 to mate with the second connector 102, and then the second connector 102 and the first connector 101 transmit signals to the circuit board 104, thereby achieving signal transmission between an external device and the electronic device.

It should be noted that the electronic device may be a computer case, a mobile phone, a tablet, a laptop, a television, etc. that requires signal transmission. When the height of the second installation surface 1032 inside the shell 103 changes due to product thickness design or connection height adjustment, because the first terminal 1011 in the first connector 101 has the abutting segment 10111 extending in the first direction, the abutting segment 10111 may serve as an intermediate connector to achieve signal transmission between the second connector 102 and the circuit board 104, and the second connector 102 may be mated with the first connector 101 at any height position, thereby improving the adaptability of the connection assembly to different installation surface heights, increasing utilization, and lowering costs for re-designing connectors when the installation surface height of the shell 103 changes.

In some preferred embodiments of the present application, as shown in FIG. 17, the connection assembly may be a Type-C connection assembly, that is, the second connector 102 has a Type-C interface, which has forward and reverse insertion functions, supports high-speed data transmission standards of USB 3.1 and higher versions, and can achieve a maximum transmission rate of 10Gbps. In addition, the Type-C may be connected to various devices, such as a mobile phone, a tablet, a laptop, or a television, with stronger universality and wider application.

With reference to FIGS. 1 to 17, in some embodiments of the present application, an assembly method for the foregoing connection assembly 100 is as follows:

Step one: The circuit board 104 is arranged on the first installation surface 1031, and assembly positioning between the circuit board 104 and the shell 103 is implemented through the second positioning portion 1033 and the third positioning portion 1041;

Step two: The first connector 101 is arranged on the circuit board 104, and assembly positioning between the circuit board 104 and the first connector 101 is implemented through the fourth positioning portion 1042 and the fifth positioning portion 1013; the plurality of positioning segments 10112 are crimped onto the plurality of conductive portions 1044 of the circuit board 104 through the plurality of first positioning portions 10121, and the grounding members 1014 are crimped onto the grounding portions 1043 of the circuit board 104; if necessary, the positioning segments 10112 may be welded to the conductive portions 1044, and the grounding members 1014 may be welded to the grounding portions 1043.

Step three: The second connector 102 is preliminarily positioned through the limit boss 1034, and then the seventh positioning portion 1024 on the second connector 102 is mated with the sixth positioning portion 1036 on the second installation surface 1032; in the installation process, certain pressure is applied to the second connector 102, so that the elastic contact portion 10211 abuts against the abutting segment 10111 of the first terminal 1011 in the pre-loaded state;

Step four: The screw is sequentially inserted into the second connecting portion 1023 and the first connecting portion 1035 to fixedly connect the second connector 102 and the shell 103.

In order to solve the technical problem in the prior art that the integrity and reliability of information transmission are susceptible to crosstalk during signal transmission through an adapter connector, the present application provides an adapter connector and a connector assembly. The adapter connector may be used for indirect connection between an interface connector and a circuit board 208, so as to adjust the layout and size of a connection point between the interface connector and the circuit board 208. Meanwhile, a large anti-crosstalk space 203 formed between two rows of terminals of the adapter connector can reduce crosstalk generated by the terminals inside the adapter connector during signal transmission and avoid the impact of crosstalk on the integrity and reliability of information transmission.

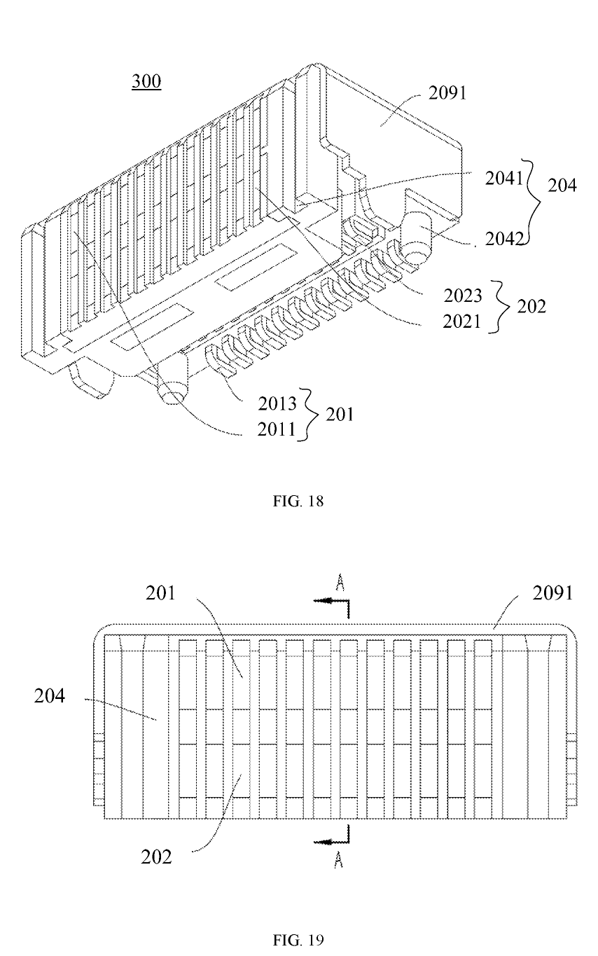

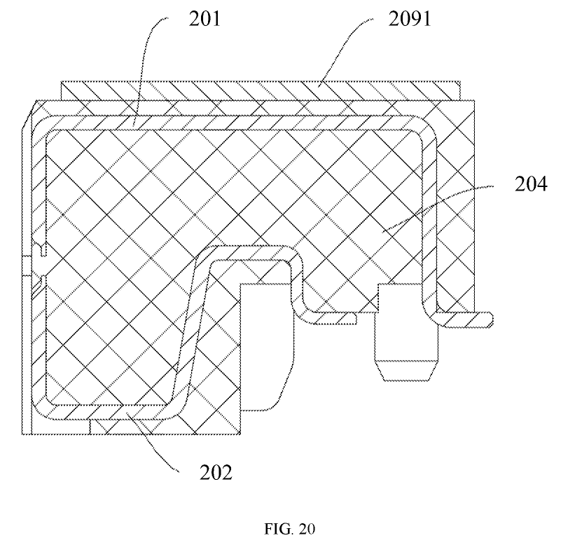

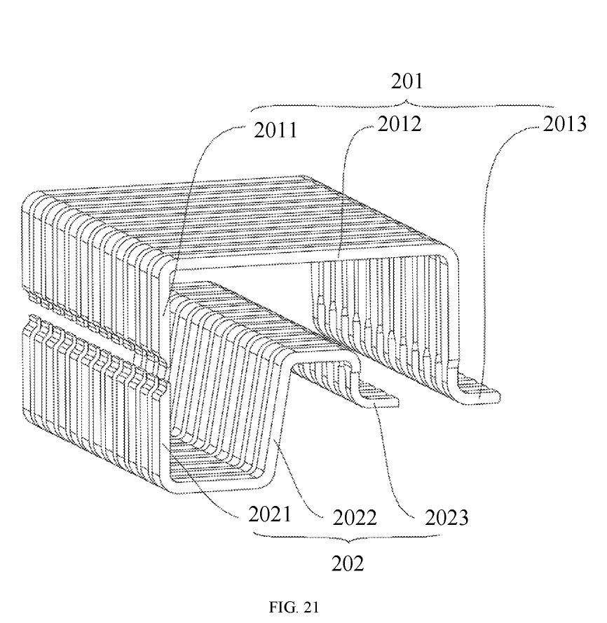

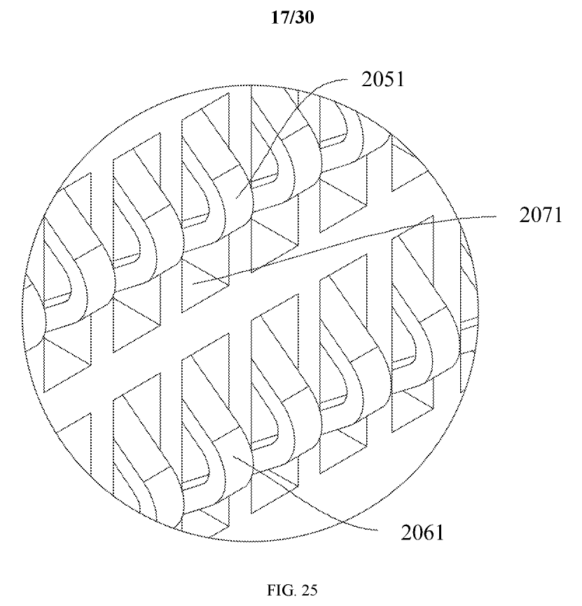

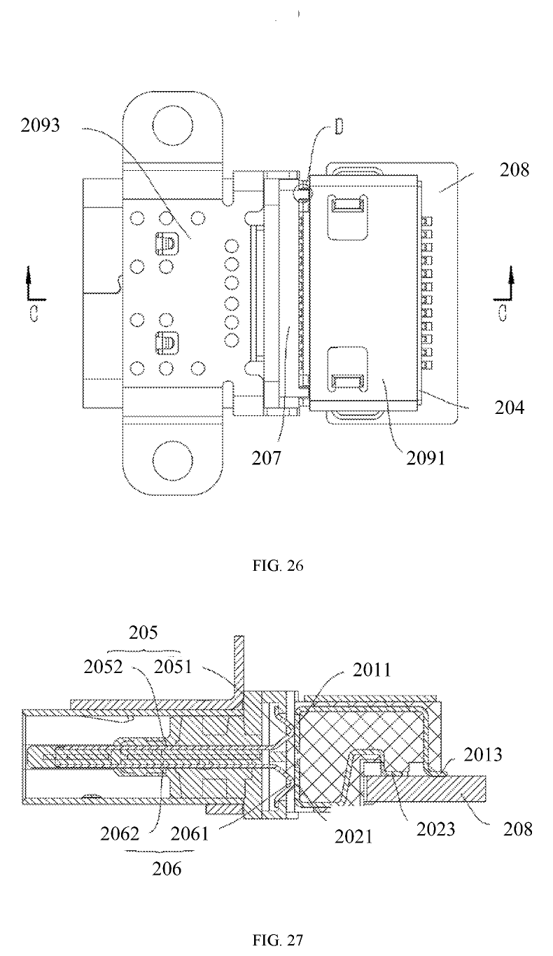

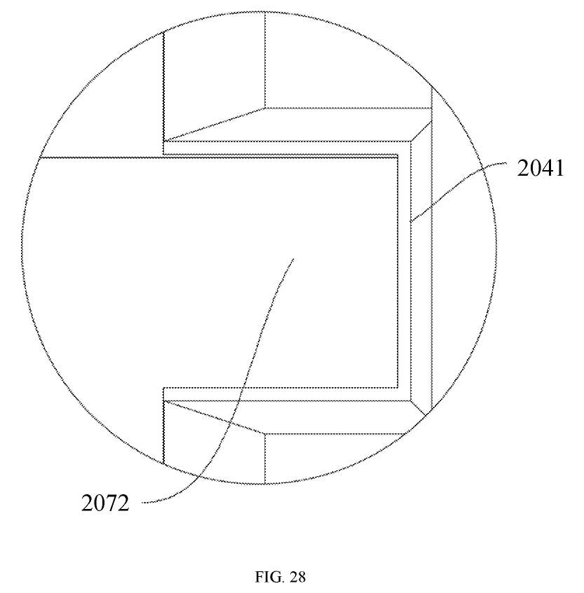

With reference to FIGS. 18 to 29, an embodiment of the present application provides an adapter connector 300, including a first terminal unit and a second terminal unit, where the first terminal unit includes a plurality of first terminals 201 arranged side by side, and the first terminal 201 includes a first connecting portion 2011, a first bent portion 2012, and a second connecting portion 2013 connected in sequence, where the first connecting portion 2011 is used to connect with a signal terminal in the interface connector, and the second connecting portion 2013 is used to connect with the circuit board 208, as shown in FIGS. 21, 26, and 27.

The second terminal unit includes a plurality of second terminals 202 arranged side by side, and the second terminal 202 includes a third connecting portion 2021, a second bent portion 2022, and a fourth connecting portion 2023 connected in sequence, where the third connecting portion 2021 is used to connect with a signal terminal in the interface connector, and the fourth connecting portion 2023 is used to connect with the circuit board 208, as shown in FIGS. 21, 26, and 27.

The first terminal unit and the second terminal unit are sequentially arranged in a first direction to form two rows of terminal connection points in the first direction, so as to change the terminal layout of the interface connector from one row to two rows, as shown in FIG. 24, thereby decreasing the width size of the interface connector.

Both the first connecting portion 2011 and the third connecting portion 2021 extend in the first direction to form connection regions with certain lengths in the first direction, and the connection regions are matched terminal connection positions of the interface connector, thereby adapting to different center height differences between the interface connector and the circuit board 208, and improving the flexibility and convenience of connection of the adapter connector with the interface connector and the circuit board 208.

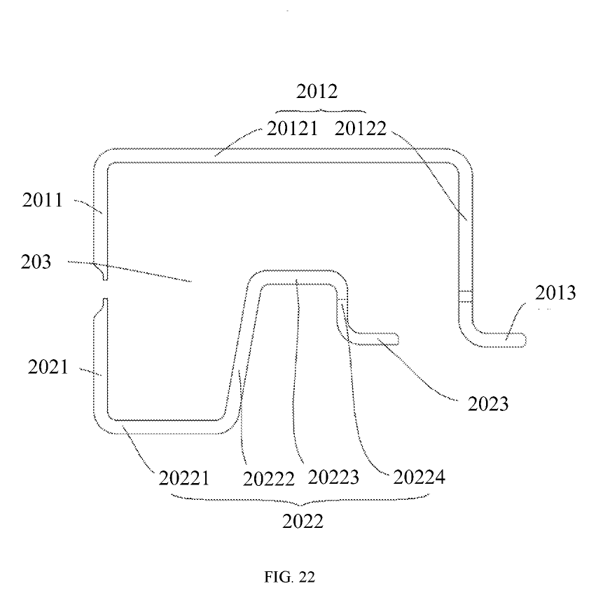

One end of the first bent portion 2012 is connected at an angle to an end, away from the third connecting portion 2021, of the first connecting portion 2011; and one end of the second bent portion 2022 is connected at an angle to an end, away from the first connecting portion 2011, of the third connecting portion 2021, where the connection can maximize the distance between the first bent portion 2012 and the second bent portion 2022, and an anti-crosstalk space 203 can be formed between the first bent portion 2012 and the second bent portion 2022, as shown in FIGS. 21 and 22.

It should be noted that the first terminal unit and the second terminal unit are arranged in two opposite rows inside the adapter connector. The first bent portion 2012 and the second bent portion 2022 are at a relatively long preset distance, thereby forming the anti-crosstalk space 203. Even if no metal shielding member is provided between the first terminal unit and the second terminal unit, crosstalk generated between any pair of first terminal 201 and second terminal 202 arranged opposite in the first direction can be reduced through the anti-crosstalk space 203, and the reduction in the crosstalk can avoid affecting the integrity and reliability of information transmission, thereby reducing or avoiding adverse effects of the adapter connector on the integrity and reliability of information transmission between the interface connector and the circuit board 208.

In the foregoing embodiment, the connection angle between the first connecting portion 2011 and the first bent portion 2012 is preferably a right angle or obtuse angle, so that the first bent portion 2012 is as far away from the second bent portion 2022 as possible. Similarly, the connection angle between the third connecting portion 2021 and the second bent portion 2022 is preferably a right angle or obtuse angle, so that the second bent portion 2022 is as far away from the first bent portion 2012 as possible, thereby expanding the distance between the first bent portion 2012 and the second bent portion 2022.

In some preferred embodiments of the present application, as shown in FIGS. 21 and 22, the first bent portion 2012 includes a first straight segment 20121, and one end of the first straight segment 20121 is vertically connected to the end, away from the third connecting portion 2021, of the first connecting portion 2011, so that the first straight segment 20121 extends in a direction perpendicular to the first direction, avoiding increasing the size of the adapter connector in the first direction when the first straight segment 20121 excessively protrudes from the first connecting portion 2011 (i.e., protrudes towards the upper side in FIG. 22).

The second bent portion 2022 includes a second straight segment 20221, and one end of the second straight segment 20221 is vertically connected to the end, away from the first connecting portion 2011, of the third connecting portion 2021, so that the second straight segment 20221 extends in a direction perpendicular to the first direction, avoiding increasing the size of the adapter connector in the first direction when the second straight segment 20221 excessively protrudes from the third connecting portion 2021 (i.e., protrudes towards the lower side in FIG. 22).

It should be noted that the first straight segment 20121 is arranged parallel to the second straight segment 20221. Due to the symmetry of parallel trace arrangement of the first straight segment 20121 and the second straight segment 20221 towards external electromagnetic fields, some interference signals can be cancelled out to improve the stability of the adapter connector in complex electromagnetic environments.

In some embodiments of the present application, as shown in FIGS. 21 and 22, the first straight segment 20121 is arranged parallel to the second straight segment 20221, and the length of the first straight segment 20121 is greater than that of the second straight segment 20221; the projection of the second bent portion 2022 and the fourth connecting portion 2023 in the first direction overlaps with the projection of the first straight segment 20121, where the overlap facilitates misalignment of the fourth connecting portion 2023 and the second connecting portion 2013, and avoids interference between a plurality of fourth connecting portions 2023 and a plurality of second connecting portions 2013, thereby facilitating misalignment connections of the fourth connecting portion 2023 and the second connecting portion 2013 with the circuit board 208. Meanwhile, the projections of the two rows of terminals on the circuit board 208 partially overlap to reduce the layout area of the circuit board 208.

In some embodiments of the present application, as shown in FIGS. 21, 22, 26, and 27, the second connecting portion 2013 and the fourth connecting portion 2023 are coplanar, facilitating their connections with the circuit board 208 on the same side, and achieving a compact connection between the adapter connector and the circuit board 208.

In the foregoing embodiments, the shape of the first bent portion 2012 may be designed according to the relative position between the first connecting portion 2011 and the second connecting portion 2013, and the shape of the second bent portion 2022 may be designed according to the relative position between the third connecting portion 2021 and the fourth connecting portion 2023. As long as the anti-crosstalk space 203 can be formed between the first bent portion 2012 and the second bent portion 2022, their shapes can achieve the objective of the present application.

In some preferred embodiments of the present application, as shown in FIGS. 21 and 22, the first bent portion 2012 is of a horizontal L-shaped structure, and the second bent portion 2022 is of a horizontal S-shaped structure. An opening direction of the L-shaped structure faces the second bent portion 2022 to maximize the relative distance between the first bent portion 2012 and the second bent portion 2022, thereby ensuring the anti-crosstalk effect of the anti-crosstalk space 203.

Specifically, the first direction is the vertical direction, the first bent portion 2012 of the first terminal 201 includes a first straight segment 20121 and a first vertical segment 20122 connected in an L-shape, and the first vertical segment 20122 is vertically connected to the second connecting portion 2013, making the entire first terminal 201 in an approximately n-shape. The second bent portion 2022 of the second terminal 202 includes a second straight segment 20221, an inclined segment 20222, a third straight segment 20223, and a second vertical segment 20224 connected in an S-shape, where the second vertical segment 20224 is vertically connected to the fourth connecting portion 2023, and the second connecting portion 2013 and the fourth connecting portion 2023 are coplanar and are both connected to the circuit board 208. The direction of the second bent portion 2022 may be changed by the arrangement of the inclined segment 20222, the third straight segment 20223, and the second vertical segment 20224, facilitating the connection between the second bent portion 2022 and the fourth connecting portion 2023 and adapting to the installation height of the circuit board 208.

It should be noted that the first terminal 201 and the second terminal 202 are both connected through rounded corners in bent regions, which can disperse stress, avoid abrupt impedance changes, and ensure the transmission quality of high-speed signals (such as 10Gbps or above).

With reference to FIGS. 18 to 29, an embodiment of the present application provides a connector assembly, including the adapter connector described in the foregoing embodiments, and further including an interface connector, where a tail end of the interface connector is provided with a third terminal unit and a fourth terminal unit arranged in sequence in the first direction;

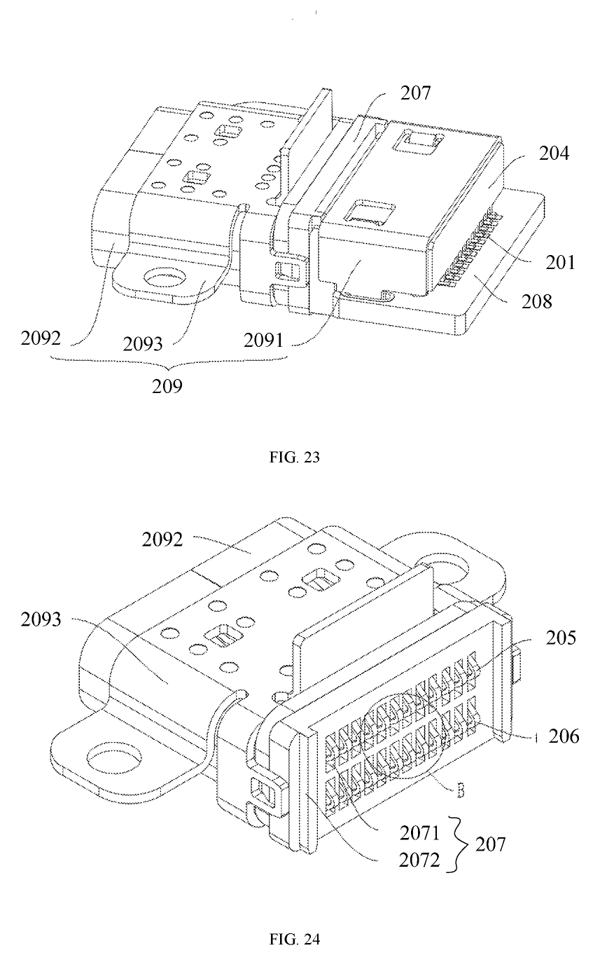

The third terminal unit includes a plurality of third terminals 205 arranged side by side, the third terminal 205 includes a first elastic portion 2051 facing the first terminal 201, and the first elastic portion 2051 elastically abuts against the first connecting portion 2011 to conduct the third terminal 205 and the first terminal 201; and the fourth terminal unit includes a plurality of fourth terminals 206 arranged side by side, the fourth terminal 206 includes a second elastic portion 2061 facing the second terminal 202, and the second elastic portion 2061 elastically abuts against the third connecting portion 2021 to conduct the fourth terminal 206 and the second terminal 202, as shown in FIGS. 23, 24, 25, and 27.

It should be noted that both the first connecting portion 2011 and the second connecting portion 2013 extend in the first direction to form a connection region with a certain length in the first direction, where the connection region may be used to abut against the first elastic portion 2051 or the second elastic portion 2061. The adapter connector may move relative to the tail end of the interface connector in the first direction. Specifically, when the first direction is the vertical direction, the adapter connector slides up and down relative to the tail end of the interface connector to support different connection heights, thereby greatly improving product performance.

In some embodiments of the present application, the adapter connector includes a first insulating body 204, and both the first terminal unit and the second terminal unit are embedded inside the first insulating body 204, achieving the fixation of the first terminal unit and the second terminal unit, as shown in FIGS. 18, 19, and 20; and the interface connector includes a second insulating body 207, and both the third terminal unit and the fourth terminal unit are embedded inside the second insulating body 207, achieving the fixation of the third terminal unit and the fourth terminal unit, as shown in FIGS. 23, 24, and 27.

The first insulating body 204 is provided with a first clamping portion 2041 on a side facing the second insulating body 207, the second insulating body 207 is provided with a second clamping portion 2072 on a side facing the first insulating body 204, and the first clamping portion 2041 is matched with the second clamping portion 2072 to achieve assembly positioning between the first insulating body 204 and the second insulating body 207, so that the plurality of third terminals 205 abut against the plurality of first terminals 201 in one-to-one correspondence, and the plurality of fourth terminals 206 abut against the plurality of second terminals 202 in one-to-one correspondence, ensuring the mating accuracy between the interface connector and the adapter connector, as shown in FIGS. 18, 24, 26, and 28.

In some preferred embodiments of the present application, as shown in FIGS. 18, 24, 26, and 28, the first clamping portion 2041 or the second clamping portion 2072 is a chute, and the chute extends in the first direction. When the assembly positions of the adapter connector and the interface connector are adjusted according to connection height requirements, the chute is used for sliding guidance in the first direction, ensuring the mating accuracy between the adapter connector and the interface connector.

In some embodiments of the present application, as shown in FIGS. 24, 25, and 27, a tail end of the second insulating body 207 is provided with a plurality of limit grooves 2071, and the plurality of limit grooves 2071 correspond one to one with the plurality of first elastic portions 2051 and the plurality of second elastic portions 2061, achieving the spacing and limit between any two elastic portions (including one first elastic portion 2051 and one second elastic portion 2061). Both the first elastic portions 2051 and the second elastic portions 2061 protrude from the limit grooves 2071 and are used to abut against the first connecting portions 2011 and the second connecting portions 2013, respectively.

It should be noted that the ends of the first elastic portions 2051 and the second elastic portions 2061 abut against inner sides of the limit grooves 2071, as shown in FIG. 27. The elastic portions may partially protrude from the limit grooves 2071, and the elastic portions will not completely protrude to the outside of the limit grooves 2071 during deformation, ensuring the reliability of elastic abutting functions of the elastic portions.

In some embodiments of the present application, as shown in FIG. 27, the third terminal 205 includes a fifth connecting portion 2052, the fifth connecting portion 2052 is connected to the first elastic portion 2051, and the fifth connecting portion 2052 is embedded on an upper side of an insulating tongue of the second insulating body 207; and the fourth terminal 206 includes a sixth connecting portion 62, the sixth connecting portion 62 is connected to the second elastic portion 2061, and the sixth connecting portion 62 is embedded on a lower side of the insulating tongue of the second insulating body 207. Such design can achieve the fixation of the third terminal 205 and the fourth terminal 206. When the first elastic portion 2051 and the second elastic portion 2061 are abutted, the fixed third terminal and fourth terminal can provide reaction force to the first elastic portion 2051 and the second elastic portion 2061 respectively.

In some embodiments of the present application, as shown in FIGS. 23, 27, and 29, the connector assembly further includes a circuit board 208, and both the second connecting portion 2013 and the fourth connecting portion 2023 are connected to the circuit board 208, thereby achieving information transmission between the interface connector and the circuit board 208 through the plurality of first terminals 201 and the plurality of second terminals 202.

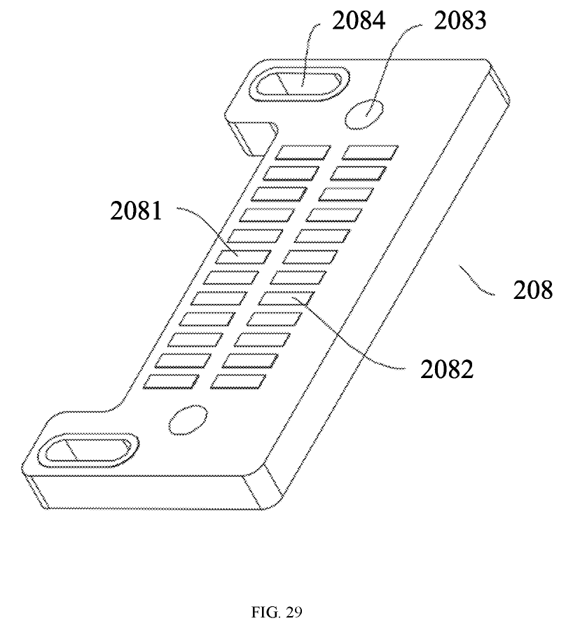

In some embodiments of the present application, as shown in FIG. 29, the circuit board 208 includes two rows of conductive regions arranged in sequence in a second direction, and each row of conductive regions includes a plurality of conductive points, where the plurality of conductive points in one row of conductive regions are correspondingly connected to the plurality of second connecting portions 2013, and the plurality of conductive points in the other row of conductive regions are correspondingly connected to the plurality of fourth connecting portions 2023. The two rows of conductive regions are correspondingly conducted with the two terminal units (i.e., the first terminal unit and the second terminal unit) in the adapter connector, achieving a compact layout design of the circuit board 208 and decreasing the width size of the circuit board 208.

Specifically, the second direction is the horizontal direction, and the two rows of conductive regions are respectively denoted as first conductive regions 2081 and second conductive regions 2082, where the first conductive regions 2081 are located on a side, near the adapter connector, of the circuit board 208 and used to conduct with the fourth connecting portions 2023 of the second terminals 202; and the second conductive regions 2082 are located on a side, away from the adapter connector, of the circuit board 208 and used to conduct with the second connecting portions 2013 of the first terminals 201. The arrangement of the conductive regions is matched with that of the first terminals 201 and the second terminals 202, as shown in FIG. 27.

In some embodiments of the present application, as shown in FIGS. 18, 23, and 29, the first insulating body 204 is provided with a first positioning portion 2042 at the bottom, the circuit board 208 is provided with a second positioning portion 2083, and the second positioning portion 2083 is matched with the first positioning portion 2042. The engagement of the first positioning portion 2042 and the second positioning portion 2083 can achieve assembly positioning between the second connecting portions 2013 and the second conductive regions 2082, and between the fourth connecting portions 2023 and the first conductive regions 2081.

Specifically, the first positioning portion 2042 is a positioning column, the positioning column is arranged on both sides of the bottom of the first insulating body 204, the second positioning portion 2083 is a positioning hole, and the positioning hole is arranged on both sides of the circuit board 208. The insertion of the positioning column into the corresponding positioning hole on the corresponding side can achieve assembly positioning between the adapter connector and the circuit board 208.

In some embodiments of the present application, as shown in FIGS. 23 and 24, the connector assembly further includes a shell assembly 209, where the shell assembly 209 is made of metal and may be used to achieve physical protection and electromagnetic shielding functions of the connector assembly.

Specifically, the shell assembly 209 includes a first shell 2091, a second shell 2092, and a third shell 2093, where the first shell 2091 covers the outer side of the first insulating body 204, the circuit board 208 is provided with a shell conductive portion 2084, and the shell conductive portion 2084 may be used to connect with the first shell 2091 to reach a grounding state; the second shell 2092 covers the outer side of the second insulating body 207; and the third shell 2093 covers the outer side of the second shell 2092. The shells can be used for electromagnetic shielding and installation.

With reference to FIGS. 18 to 29, in some embodiments of the present application, an assembly process of the foregoing connector assembly is as follows:

Step one: The adapter connector and the circuit board 208 are assembled and positioned through the first positioning portion 2042 and the second positioning portion 2083, so that the plurality of second connecting portions 2013 are correspondingly connected to the plurality of conductive points in the second conductive regions 2082 on the circuit board 208, and the plurality of fourth connecting portions 2023 are correspondingly connected to the plurality of conductive points in the first conductive regions 2081 on the circuit board 208;

Step two: The assembly positioning between the first insulating body 204 and the second insulating body 207 is achieved through the first clamping portion 2041 and the second clamping portion 2072, and the first clamping portion 2041 and the second clamping portion 2072 slide relative to each other in the first direction to adjust the assembly positions of the interface connector and the adapter connector, so that the first elastic portion 2051 abuts against the first connecting portion 2011, and the second elastic portion 2061 abuts against the third connecting portion 2021.

In order to solve the technical problem of difficulty in ensuring the positioning and mating accuracy between an interface connector 301 and an adapter connector 302 of a connector assembly in the prior art, the present application provides a connector assembly 400 and an electronic device 500. An adapter terminal 3022 in the adapter connector 302 of the connector assembly 400 includes a conductive portion 30221 extending in the first direction, so that the abutting position of an elastic abutting portion 30122 on an interface terminal 3012 of the interface connector 301 against the conductive portion 30221 in the first direction can be adjusted, thereby adapting to the relative position adjustment of the interface connector 301 and the adapter connector 302 in the first direction, and improving the universality of the connector assembly installed inside different electronic devices. Meanwhile, a first limit portion 30111 is provided on the first insulating body 3011 of the interface connector 301, a second limit portion 30211 is provided on the second insulating body 3021 of the adapter connector 302, the first limit portion 30111 and the second limit portion 30211 cooperate with each other, and the first limit portion 30111 and the second limit portion 30211 are slidably connected in the first direction to ensure the mating precision between the interface connector 301 and the adapter connector 302, and to ensure stable contact between the interface connector 301 and the adapter connector 302 during relative position adjustment.

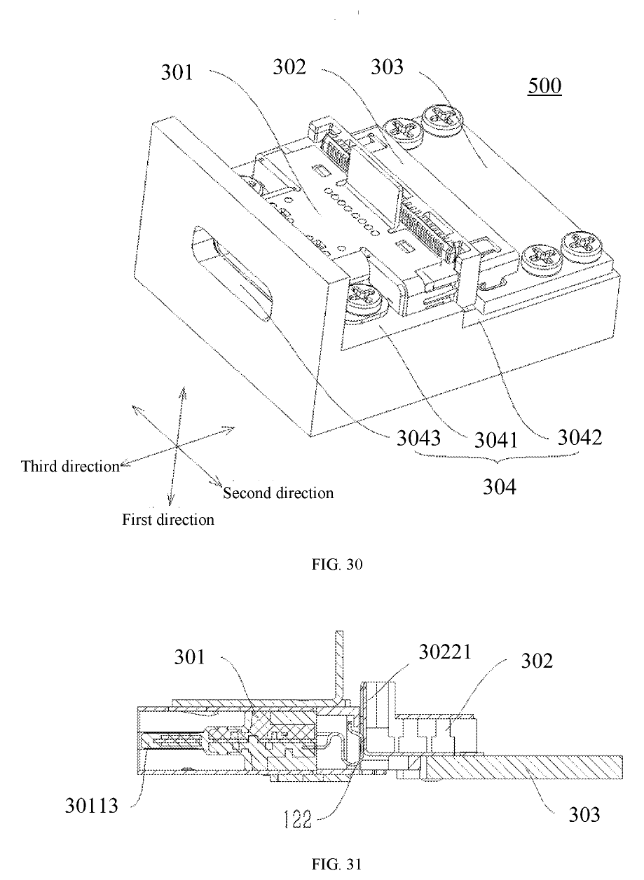

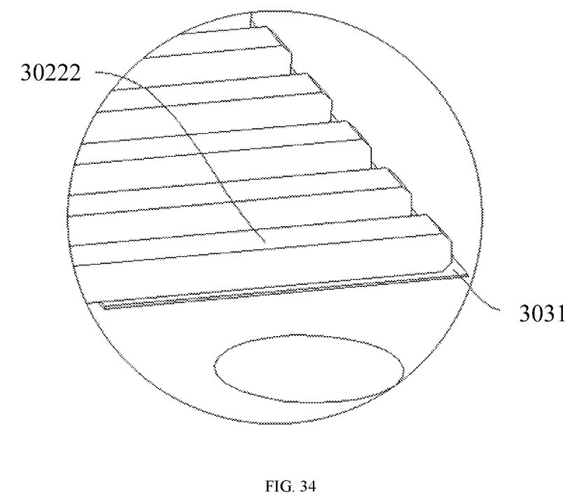

With reference to FIGS. 30 to 43, an embodiment of the present application provides a connector assembly 400, including an interface connector 301 and an adapter connector 302, where the interface connector 301 includes a first insulating body 3011 and a plurality of interface terminals 3012, and the plurality of interface terminals 3012 may be used to achieve information transmission between the connector assembly and other external devices. The plurality of interface terminals 3012 are arranged in the first insulating body 3011, achieving fixation and spacing maintenance of the plurality of interface terminals 3012 inside the interface connector 301. The interface terminal 3012 includes a mating portion 30121 and an elastic abutting portion 30122, where the mating portion 30121 is arranged at a front end of the interface terminal 3012 and used to connect with mating connectors of other electronic devices; and the elastic abutting portion 30122 is arranged at a tail end of the interface terminal 3012 and may be conducted with the adapter connector 302 through elastic abutment, thereby achieving information transmission between the interface connector 301 and the adapter connector 302, as shown in FIGS. 31, 32, and 33.

The adapter connector 302 includes a second insulating body 3021 and a plurality of adapter terminals 3022, where the plurality of adapter terminals 3022 may be used for information transmission between the interface connector 301 and the circuit board 303 or other electronic devices. The plurality of adapter terminals 3022 are arranged in the second insulating body 3021, achieving fixation and spacing maintenance of the plurality of adapter terminals 3022 inside the adapter connector 302. A front end of the adapter terminal 3022 is provided with a conductive portion 30221 extending in a first direction, as shown in FIG. 36, and the plurality of conductive portions 30221 are arranged in one-to-one contact with the plurality of elastic abutting portions 30122, as shown in FIGS. 31, 32, and 33. Through the elastic force of the elastic abutting portion 30122, the elastic abutting portion 30122 stably abuts against the conductive portion 30221. When the interface terminal 3012 and/or the adapter terminal 3022 experience minor displacement due to vibration, thermal expansion and contraction, or long-term use, the elastic deformation of the elastic abutting portion 30122 can automatically compensate for the gap to maintain stable contact pressure between the elastic abutting portion 30122 and the conductive portion 30221. Meanwhile, because the conductive portion 30221 extends in the first direction, the abutting position of the elastic abutting portion 30122 can be adjusted in the first direction to meet different relative position requirements between the interface connector 301 and the adapter connector 302, whereby the connector assembly can be arranged on different installation structures, improving the universality of the connector assembly.

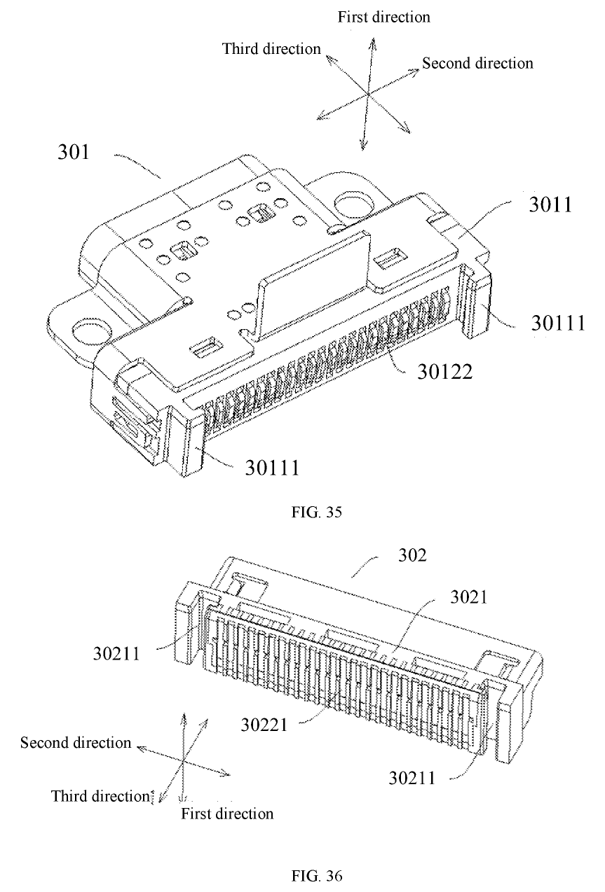

With reference to FIGS. 35 to 41, the first insulating body 3011 is provided with a first limit portion 30111 extending in the first direction at an end facing the second insulating body 3021, as shown in FIG. 35; the second insulating body 3021 is provided with a second limit portion 30211 extending in the first direction at an end facing the first insulating body 3011, as shown in FIG. 36; the first limit portion 30111 and the second limit portion 30211 cooperate with each other to achieve assembly positioning between the interface connector 301 and the adapter connector 302; the first limit portion 30111 is slidably connected to the second limit portion 30211 in the first direction; when the abutting position of the elastic abutting portion 30122 against the conductive portion 30221 in the first direction changes, the relative sliding of the first limit portion 30111 and the second limit portion 30211 in the first direction can provide stable positioning and adjustment guidance. The sliding distance of the first limit portion 30111 matches the size of the conductive portion 30221 in the first direction, so that the relative sliding range between the first limit portion 30111 and the second limit portion 30211 covers the relative position adjustment range between the interface connector 301 and the adapter connector 302 in the first direction, ensuring that the interface connector 301 and the adapter connector 302 can maintain stable contact during relative position adjustment.

In some preferred embodiments of the present application, as shown in FIGS. 35 and 36, the sliding distance of the first limit portion 30111 is greater than or equal to the size of the conductive portion 30221 in the first direction. During the sliding of the first limit portion 30111 relative to the second limit portion 30211, the elastic abutting portion 30122 can elastically abut against any point on the conductive portion 30221, expanding the relative position adjustment range between the interface connector 301 and the adapter connector 302 in the first direction.

In some embodiments of the present application, as shown in FIGS. 35 to 41, the first limit portion 30111 is a limit block, and the limit block protrudes from an end surface of the first insulating body 3011; the second limit portion 30211 is a limit groove, and the limit groove is recessed in an end surface of the second insulating body 3021. Through the cooperation between the limit block and the limit groove, mutual cooperation and sliding connection in the first direction between the first limit portion 30111 and the second limit portion 30211can be achieved simultaneously. In addition, the limit groove penetrates the second insulating body 3021 in the first direction, thereby reducing the manufacturing difficulty of the limit groove and the mating difficulty between the first insulating body 3011 and the second insulating body 3021 (i.e., the limit block may slide in from any end of the limit groove to achieve connection). Meanwhile, the size of the limit groove in the first direction may be greater than that of the conductive portion 30221, thereby ensuring that the sliding distance of the first limit portion 30111 is greater than or equal to the size of the conductive portion 30221 in the first direction.

Alternatively, the first limit portion 30111 may be a limit groove, and the limit groove is recessed in an end surface of the first insulating body 3011, while the second limit portion 30211 is a limit block, and the limit block protrudes from an end surface of the second insulating body 3021. As long as mutual cooperation and sliding connection in the first direction between the first limit portion 30111 and the second limit portion 30211 can be achieved, the objective of the present application can be achieved.

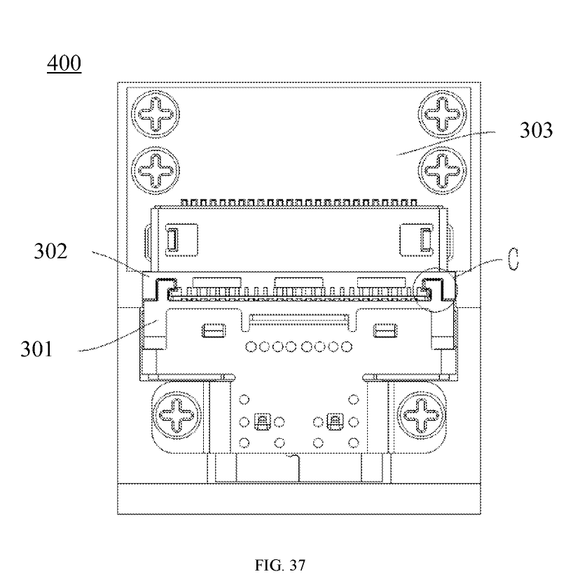

In some embodiments of the present application, as shown in FIGS. 37 to 41, the first limit portion 30111 includes a protrusion 301111 protruding in a second direction, where the second direction is perpendicular to the first direction. The cross-sectional shape of the first limit portion 30111 may be irregular, thereby achieving multi-surface contact between the first limit portion 30111 and the second limit portion 30211 and limiting the degrees of freedom in a plurality of directions to achieve high-precision positioning.

In some embodiments of the present application, as shown in FIGS. 30, 35, and 38 to 41, the first direction is a vertical direction, the second direction is a left-right direction within a horizontal plane, a body portion 301112 of the first limit portion 30111 extends in a third direction within the horizontal plane, and the third direction is a front-back direction within the horizontal plane, as shown in FIGS. 30 and 35. It may be understood that every two of the first direction, the second direction, and the third direction are perpendicular to each other. When the protrusion 301111 protrudes in the second direction, the first limit portion 30111 and the second limit portion 30211 may slide relative to each other in the vertical direction, but can limit each other in the left-right direction and the front-back direction, thereby positioning and limiting the interface connector 301 and the adapter connector 302 in front, back, left, and right directions.

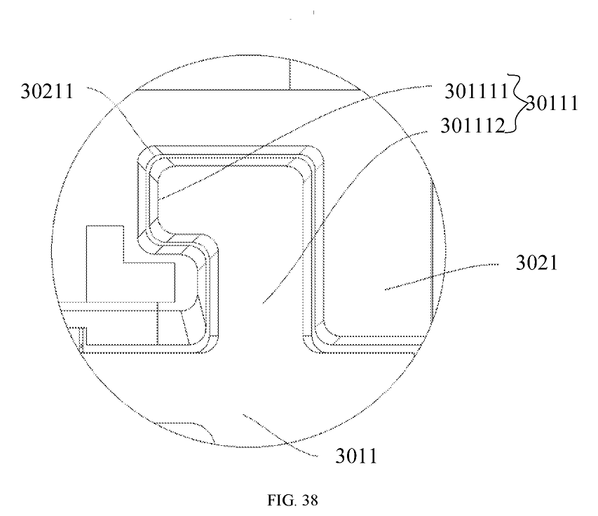

In some embodiments of the present application, as shown in FIGS. 38 to 41, in the second direction, the protrusion 301111 is arranged on one side or two sides of the first limit portion 30111 to achieve multi-directional positioning and limiting.

In some embodiments of the present application, as shown in FIGS. 38 to 41, the cross-section of the first limit portion 30111 is L-shaped, T-shaped, P-shaped, or gourd hole-shaped, all of which enable the body portion 301112 and the protrusion 301111 of the first limit portion 30111 to extend in two mutually perpendicular directions.

In some embodiments of the present application, as shown in FIGS. 37 and 38, when the cross-section of the first limit portion 30111 is L-shaped, the protrusion 301111 is located on a side of one end of the body portion 301112, and the side is near the second insulating body 3021, so that the cross-section of the first limit portion 30111 is inverted L-shaped within the horizontal plane in FIG. 38, achieving the limiting of the interface connector 301 and the adapter connector 302 in the front, back, left, and right directions.

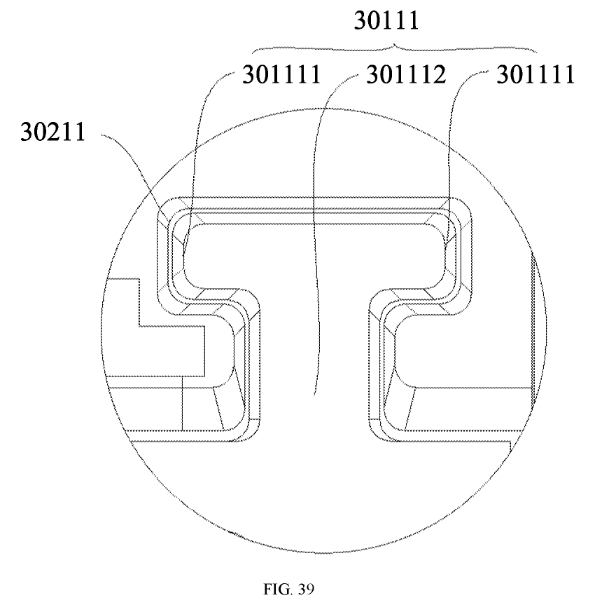

In other embodiments of the present application, as shown in FIG. 39, when the cross-section of the first limit portion 30111 is T-shaped, the protrusions 301111 are symmetrically arranged on two sides of one end of the body portion 301112, and the two sides are near the second insulating body 3021, thereby further enlarging the contact area between the first limit portion 30111 and the second limit portion 30211, improving the stability of cooperation between the first limit portion 30111 and the second limit portion 30211, and also achieving the limiting of the interface connector 301 and the adapter connector 302 in the front, back, left, and right directions.

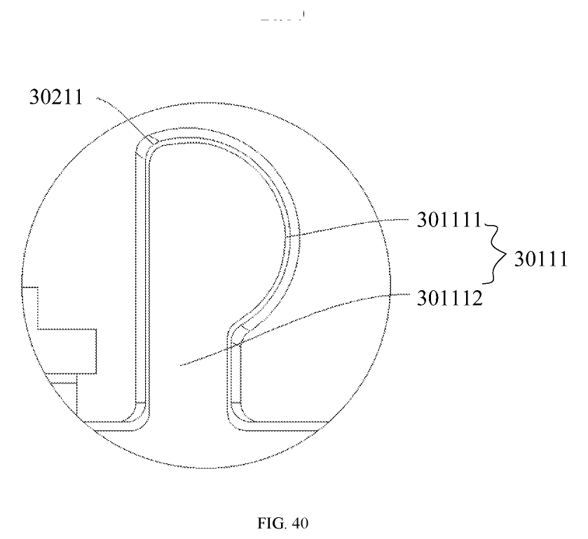

In other embodiments of the present application, as shown in FIG. 40, when the cross-section of the first limit portion 30111 is P-shaped, the protrusion 301111 is located on a side of one end of the body portion 301112, and the side is near the second insulating body 3021, whereby the first limit portion 30111 and the second limit portion 30211 can be limited in a plurality of directions through an arc-shaped contact surface, and the interface connector 301 and the adapter connector 302 can also be limited in the front, back, left, and right directions.

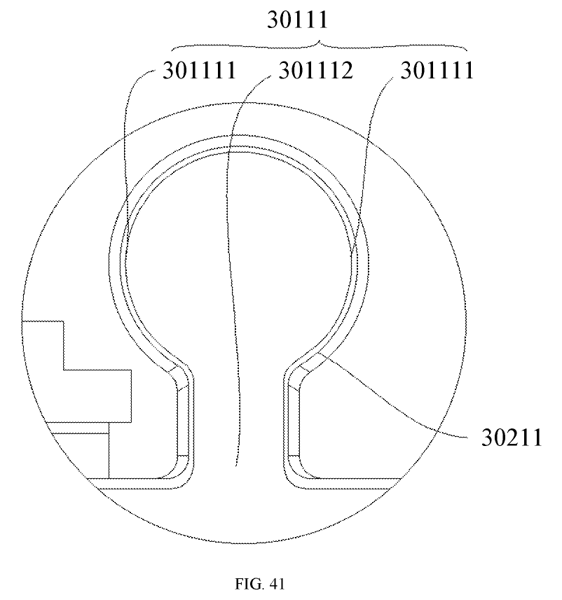

In other embodiments of the present application, as shown in FIG. 41, when the cross-section of the first limit portion 30111 is gourd hole-shaped, the protrusions 301111 are symmetrically arranged on two sides of one end of the body portion 301112, and the two sides are near the second insulating body 3021, where precise positioning connection between the first limit portion 30111 and the second limit portion 30211 can be achieved through cross-sectional dimension changes of the first limit portion 30111 in the second direction (i.e., the left-right direction) and the third direction (i.e., the front-back direction), and the interface connector 301 and the adapter connector 302 can also be limited in the front, back, left, and right directions.

In some embodiments of the present application, as shown in FIGS. 35 and 36, the first limit portions 30111 are symmetrically arranged on two sides of an end of the first insulating body 3011, and the second limit portions 30211 are symmetrically arranged on two sides of an end of the second insulating body 3021, thereby achieving a balanced and symmetrical sliding connection between the first insulating body 3011 and the second insulating body 3021, and improving the smoothness and accuracy of relative position adjustment between the interface connector 301 and the adapter connector 302. After the relative positions of the interface connector 301 and the adapter connector 302 are adjusted in place, the interface connector 301 and the adapter connector 302 can be fixedly installed through fasteners such as screws.

In some embodiments of the present application, as shown in FIGS. 31, 32, 35, 42, and 43, the first insulating body 3011 includes an insulating block 30112 and an insulating tongue plate 30113, where the first limit portion 30111 and the insulating tongue plate 30113 are arranged at two ends of the insulating block 30112 respectively; the plurality of interface terminals 3012 are arranged in the insulating tongue plate 30113 and the insulating block 30112, and the elastic abutting portion 30122 extends out from an open slot at a tail end of the insulating block 30112 to facilitate elastic abutment against the conductive portion 30221 of the adapter terminal 3022.

The plurality of interface terminals 3012 include a plurality of first terminals and a plurality of second terminals, where the first terminal includes a first mating portion 30121a extending in a third direction, and the first mating portion 30121a is arranged on a first surface 301131 of the insulating tongue plate 30113; the second terminal includes a second mating portion 30121b extending in the third direction, and the second mating portion 30121b is arranged on a second surface 301132 of the insulating tongue plate 30113. The plurality of interface terminals 3012 may be arranged on the two surfaces of the insulating tongue plate 30113 to achieve forward and reverse insertion functions of the interface connector 301.

Meanwhile, as the first mating portion 30121a is fixed on the first surface 301131 of the insulating tongue plate 30113, the front end of the first terminal can be fixed. When the elastic abutting portion 30122 is subjected to a force from the conductive portion 30221, the insulating tongue plate 30113 can provide a reaction force for the first terminal, thereby achieving compression of the elastic abutting portion 30122. Correspondingly, as the second mating portion 30121b is fixed on the second surface 301132 of the insulating tongue plate 30113, the front end of the second terminal can be fixed. When the elastic abutting portion 30122 is subjected to a force from the conductive portion 30221, the insulating tongue plate 30113 can provide a reaction force for the second terminal, thereby achieving compression of the elastic abutting portion 30122.

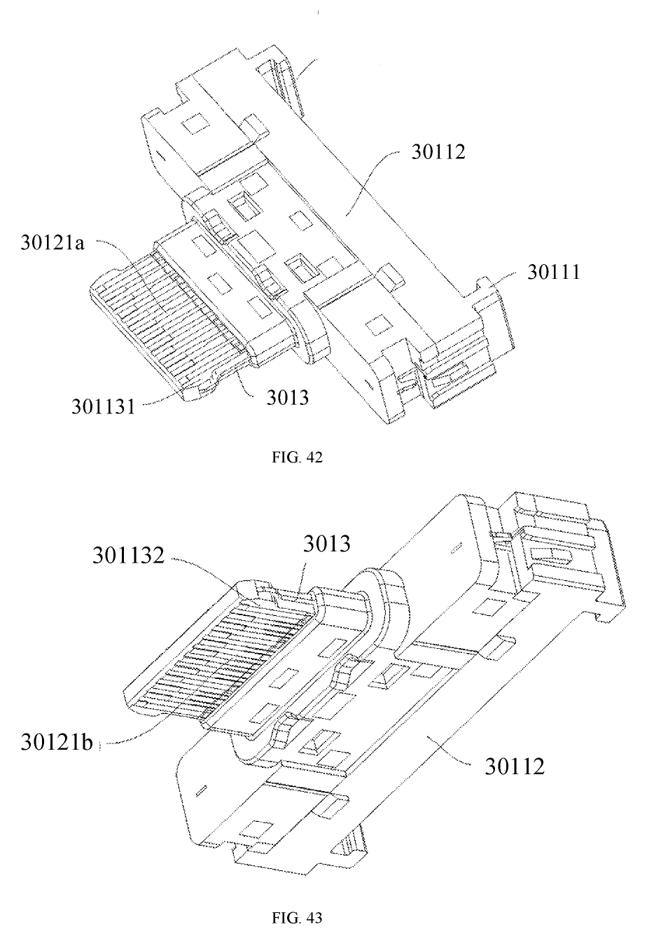

As a specific embodiment of the present application, as shown in FIGS. 42 and 43, the first terminals are the upper row of terminals of the interface connector 301, the second terminals are the lower row of terminals of the interface connector 301, the first surface 301131 is the upper surface of the insulating tongue plate 30113, and the second surface 301132 is the lower surface of the insulating tongue plate 30113. The insulating tongue plate 30113 can be used to provide structural support and fix the front ends of the upper row of terminals and the lower row of terminals, so as to improve the stability of elastic abutment between the interface terminals 3012 and the adapter terminals 3022.

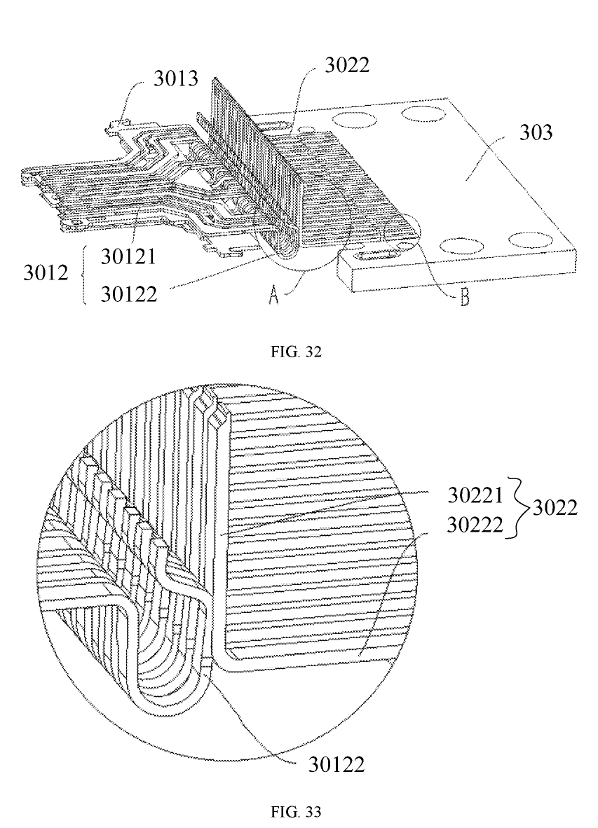

In some embodiments of the present application, as shown in FIGS. 32, 42, and 43, the interface connector 301 further includes a shielding member 3013, the shielding member 3013 is arranged inside the first insulating body 3011, and the shielding member 3013 is located between the first surface 301131 and the second surface 301132 to form a physical isolation barrier between the first terminals and the second terminals. The shielding member 3013 made of metal can effectively absorb or reflect external electromagnetic waves, prevent high-frequency signals (such as 40Gbps data transmission of USB C) from external interference, also prevent electromagnetic radiation generated by the connector from affecting other devices, and avoid crosstalk caused by the small spacing between the first terminals and the second terminals arranged on the insulating tongue plate 30113.

In some embodiments of the present application, as shown in FIGS. 30, 31, 32, and 34, the connector assembly further includes a circuit board 303, and the circuit board 303 is provided with a plurality of connecting portions 3031. The plurality of connecting portions 3031 are connected to the plurality of adapter terminals 3022 in one-to-one correspondence, thereby achieving information transmission between the adapter connector 302 and the circuit board 303. Since the arrangement direction of the plurality of connecting portions 3031 matches the arrangement direction of the plurality of adapter terminals 3022, the structural layout of the connector assembly can be rational and compact, and the space occupation of the connector assembly inside the electronic device can be reduced.

In some preferred embodiments of the present application, as shown in FIGS. 30, 31, 32, 33, and 34, the circuit board 303 is arranged at the bottom of the adapter connector 302, and the adapter terminal 3022 is bent into an L-shape, with the conductive portion 30221 extending in the first direction (i.e., the vertical direction) and the straight portion 30222 extending in the third direction (i.e., the front-back direction), so that the adapter connector 302 can be connected to the interface connector 301 in front and to the circuit board 303 at the bottom, the occupied areas of the adapter connector 302 and the circuit board 303 overlap, the structural layout of the connector assembly is rational and compact, and the space occupation of the connector assembly inside the electronic device is reduced.

With reference to FIGS. 30 to 43, an embodiment of the present application provides an electronic device 500, including the connector assembly described in the foregoing embodiments, and further including a shell 304, where the shell 304 is provided with a first installation surface 3041 and a second installation surface 3042, and the first installation surface 3041 and the second installation surface 3042 are at a preset distance. The preset distance may be designed according to the structural requirements of the electronic device. Specifically, the preset distance is a height difference between the first installation surface 3041 and the second installation surface 3042 in the first direction.

The interface connector 301 is arranged on the first installation surface 3041, and the adapter connector 302 is arranged on the second installation surface 3042. The cooperation between the elastic abutting portion 30122 and the conductive portion 30221 can adapt to the preset distance between the first installation surface 3041 and the second installation surface 3042 in the first direction. When the preset distances of different types of electronic devices are different, the compatibility between the connector assembly and different installation structures can be improved by adjusting the abutting position between the elastic abutting portion 30122 and the conductive portion 30221, thereby enhancing the universality of the connector assembly. During the adjustment of the abutting position between the elastic abutting portion 30122 and the conductive portion 30221, the sliding connection between the first limit portion 30111 and the second limit portion 30211 in the first direction can be used for adjustment guidance and limiting, ensuring the mating precision between the interface connector 301 and the adapter connector 302.

In some embodiments of the present application, as shown in FIG. 30, the shell 304 is further provided with an insertion hole 3043 corresponding to the interface connector 301, facilitating the insertion of other electronic devices into the insertion hole 3043 to achieve information transmission with the interface connector 301. When the height position of the insertion hole 3043 is different for different types of electronic products, adaptive installation can be achieved by adjusting the abutting position between the elastic abutting portion 30122 and the conductive portion 30221, and the mating precision between the plurality of elastic abutting portions 30122 and the plurality of conductive portions 30221 can be ensured through the first limit portion 30111 and the second limit portion 30211.

With reference to FIGS. 30 to 43, in some embodiments of the present application, an installation process of the foregoing connector device on the electronic device is as follows:

Step one: The adapter connector 302 is connected to the circuit board 303, where the plurality of adapter terminals 3022 are connected to the plurality of connecting portions 3031 on the circuit board 303 in one-to-one correspondence;

Step two: The adapter connector 302 and the circuit board 303 are entirely arranged on the second installation surface 3042 of the shell 304;

Step three: The interface connector 301 is moved from top to bottom, so that the first limit portion 30111 is inserted downward into the second limit portion 30211, and the interface connector 301 can slide relative to the adapter connector 302 in the first direction, achieving the adjustment of the abutting position between the elastic abutting portion 30122 and the conductive portion 30221;

Step four: After the relative positions of the interface connector 301 and the adapter connector 302 are adjusted in place, the interface connector 301 is fixed on the first installation surface 3041 through fasteners such as screws, and the adapter connector 302 and the circuit board 303 are entirely fixed on the second installation surface 3042.

It should be understood that the terms used herein are only for the purpose of describing specific exemplary implementations and are not intended to be restrictive. Unless otherwise explicitly stated in the context, singular forms such as "a", "one", and "the" used herein may further include plural forms. The terms "comprise", "include", "contain", and "have" are inclusive and therefore indicate the existence of the stated features, steps, operations, elements, and/or components, but do not exclude the existence or addition of one or more other features, steps, operations, elements, components, and/or combinations thereof. The method steps, processes, and operations described herein are not interpreted as requiring them to be executed in a specific order described or illustrated, unless an execution order is clearly indicated. It should also be understood that additional or alternative steps can be used.

Although the terms first, second, third, etc. can be used herein to describe a plurality of elements, components, regions, layers, and/or segments, these elements, components, regions, layers, and/or segments should not be limited by these terms. These terms can only be used for distinguishing one element, component, region, layer, or segment from another. Unless explicitly stated in the context, the terms such as "first" and "second" and other numerical terms used herein do not imply order or sequence. Therefore, the first element, component, region, layer, or segment discussed below may be referred to as the second element, component, region, layer, or segment without departing from the teachings of the example embodiments.

Described above are merely specific implementations of the present application, enabling a person skilled in the art to understand or implement the present application. Various modifications to these embodiments are apparent to the person skilled in the art. General principles defined herein may be implemented in other embodiments without departing from the spirit or scope of the present application. Therefore, the present application will not be limited to these embodiments shown herein, but will conform to the widest scope consistent with the principle and novelty of the present application.

What is claimed is:

1. A connection assembly, comprising:
a first connector, wherein the first connector comprises at least one first terminal, the first terminal has an abutting segment, and the abutting segment extends in a first direction; and
a second connector, wherein the second connector comprises at least one second terminal, the second terminal is provided with an elastic contact portion, the elastic contact portion abuts against the abutting segment, the abutting segment forms an adjustable contact zone in the first direction, the contact zone abuts against the elastic contact portion, and the second connector is at a different position relative to the first connector in the first direction.

2. The connection assembly according to claim 1, wherein the first connector further comprises a first insulating body, a portion of the first terminal is embedded in the first insulating body, the abutting segment is arranged on an edge of the first insulating body, and the edge faces the second connector.

3. The connection assembly according to claim 2, wherein the first insulating body comprises a first positioning portion, the first terminal has a positioning segment, and the positioning segment is matched with the first positioning portion.

4. The connection assembly according to claim 1, wherein the elastic contact portion is located at a tail end of the second terminal, the elastic contact portion comprises at least one bent segment, and the bent segment elastically abuts against the abutting segment.

5. The connection assembly according to claim 1, wherein the second connector further comprises a second insulating body, and the second terminal is embedded in the second insulating body; and
the second insulating body is provided with a limit groove, and a portion of the elastic contact portion extends out of the limit groove.

6. The connection assembly according to claim 1, further comprising a shell, wherein the shell comprises a first installation surface and a second installation surface, the first connector is arranged on the first installation surface, the second connector is arranged on the second installation surface, and the first installation surface and the second installation surface are at a preset distance in the first direction.

7. The connection assembly according to claim 6, further comprising a circuit board, wherein the circuit board is arranged on the first installation surface, and the first terminal is connected to the elastic contact portion and the circuit board respectively.

8. The connection assembly according to claim 7, wherein the shell comprises a second positioning portion, the second positioning portion is arranged on the first installation surface, the circuit board comprises a third positioning portion, and the third positioning portion is matched with the second positioning portion.

9. The connection assembly according to claim 7, wherein the first connector is arranged on the circuit board, the circuit board is provided with a fourth positioning portion, the first connector is provided with a fifth positioning portion, and the fifth positioning portion is matched with the fourth positioning portion.

10. The connection assembly according to claim 9, wherein the first connector is provided with grounding members at two ends, the circuit board is provided with grounding portions, and the grounding portions are correspondingly connected to the grounding members.

11. The connection assembly according to claim 6, wherein the shell further comprises a limit boss, the limit boss protrudes from the second installation surface, and the limit boss abuts against an outer wall of the second connector.

12. The connection assembly according to claim 6, wherein the shell further comprises a sixth positioning portion, the sixth positioning portion is arranged on the second installation surface, the second connector comprises a seventh positioning portion, and the seventh positioning portion is matched with the sixth positioning portion.

13. The connection assembly according to claim 6, wherein the shell further comprises a first connecting portion, the first connecting portion is arranged on the second installation surface, the second connector comprises a second connecting portion, and the second connecting portion is correspondingly connected to the first connecting portion.

14. An adapter connector, comprising:
a first terminal unit, wherein the first terminal unit comprises a plurality of first terminals arranged side by side, and the first terminal comprises a first connecting portion, a first bent portion, and a second connecting portion connected in sequence; and
a second terminal unit, wherein the second terminal unit comprises a plurality of second terminals arranged side by side, and the second terminal comprises a third connecting portion, a second bent portion, and a fourth connecting portion connected in sequence;
wherein the first terminal unit and the second terminal unit are sequentially arranged in a first direction, and both the first connecting portion and the third connecting portion extend in the first direction; one end of the first bent portion is connected at an angle to an end, away from the third connecting portion, of the first connecting portion; one end of the second bent portion is connected at an angle to an end, away from the first connecting portion, of the third connecting portion; and an anti-crosstalk space is formed between the first bent portion and the second bent portion.

15. The adapter connector according to claim 14, wherein the first bent portion comprises a first straight segment, and one end of the first straight segment is vertically connected to the end, away from the third connecting portion, of the first connecting portion; and
the second bent portion comprises a second straight segment, and one end of the second straight segment is vertically connected to the end, away from the first connecting portion, of the third connecting portion.

16. The adapter connector according to claim 15, wherein the first straight segment is arranged parallel to the second straight segment, and the length of the first straight segment is greater than that of the second straight segment; and the projection of the second bent portion and the fourth connecting portion in the first direction overlaps with the projection of the first straight segment.

17. The adapter connector according to claim 14, wherein the second connecting portion and the fourth connecting portion are coplanar.

18. The adapter connector according to claim 14, wherein the first bent portion is of a horizontal L-shaped structure, the second bent portion is of a horizontal S-shaped structure, and an opening direction of the L-shaped structure faces the second bent portion.

19. A connector assembly, comprising the adapter connector according to claim 15, and an interface connector, wherein a tail end of the interface connector is provided with a third terminal unit and a fourth terminal unit arranged in sequence in the first direction;
the third terminal unit comprises a plurality of third terminals arranged side by side, the third terminal comprises a first elastic portion facing the first terminal, and the first elastic portion elastically abuts against the first connecting portion; and
the fourth terminal unit comprises a plurality of fourth terminals arranged side by side, the fourth terminal comprises a second elastic portion facing the second terminal, and the second elastic portion elastically abuts against the third connecting portion.

20. The connector assembly according to claim 19, wherein the adapter connector comprises a first insulating body, and both the first terminal unit and the second terminal unit are embedded inside the first insulating body; the interface connector comprises a second insulating body, and both the third terminal unit and the fourth terminal unit are embedded inside the second insulating body; and
the first insulating body is provided with a first clamping portion on a side facing the second insulating body, the second insulating body is provided with a second clamping portion on a side facing the first insulating body, and the first clamping portion is matched with the second clamping portion.

21. The connector assembly according to claim 20, wherein the first clamping portion or the second clamping portion is a chute, and the chute extends in the first direction.

22. The connector assembly according to claim 20, wherein a tail end of the second insulating body is provided with a plurality of limit grooves, the plurality of limit grooves correspond one to one with the plurality of first elastic portions and the plurality of second elastic portions, and both the first elastic portions and the second elastic portions protrude from the limit grooves.

23. The connector assembly according to claim 19, further comprising a circuit board, wherein both the second connecting portion and the fourth connecting portion are connected to the circuit board.

24. The connector assembly according to claim 23, wherein the circuit board comprises two rows of conductive regions arranged in sequence in a second direction, and each row of conductive regions comprises a plurality of conductive points, wherein the plurality of conductive points in one row of conductive regions are correspondingly connected to the plurality of second connecting portions, and the plurality of conductive points in the other row of conductive regions are correspondingly connected to the plurality of fourth connecting portions.

25. A connector assembly, comprising:
an interface connector, wherein the interface connector comprises a first insulating body and a plurality of interface terminals, the plurality of interface terminals are arranged in the first insulating body, the interface terminal comprises a mating portion and an elastic abutting portion, the mating portion is arranged at a front end of the interface terminal, and the elastic abutting portion is arranged at a tail end of the interface terminal; and
an adapter connector, wherein the adapter connector comprises a second insulating body and a plurality of adapter terminals, the plurality of adapter terminals are arranged in the second insulating body, a front end of the adapter terminal is provided with a conductive portion extending in a first direction, and the plurality of conductive portions are arranged in one-to-one contact with the plurality of elastic abutting portions;
wherein the first insulating body is provided with a first limit portion extending in the first direction at an end facing the second insulating body, the second insulating body is provided with a second limit portion extending in the first direction at an end facing the first insulating body, the first limit portion and the second limit portion cooperate with each other, and the first limit portion is slidably connected to the second limit portion in the first direction.

26. The connector assembly according to claim 25, wherein the sliding distance of the first limit portion is greater than or equal to the size of the conductive portion in the first direction.

27. The connector assembly according to claim 25, wherein the first limit portion is a limit block, and the limit block protrudes from an end surface of the first insulating body; and the second limit portion is a limit groove, the limit groove is recessed in an end surface of the second insulating body, and the limit groove penetrates the second insulating body in the first direction.

28. The connector assembly according to claim 27, wherein the first limit portion comprises a protrusion protruding in a second direction, wherein the second direction is perpendicular to the first direction.

29. The connector assembly according to claim 28, wherein in the second direction, the protrusion is arranged on one side or two sides of the first limit portion.

30. The connector assembly according to claim 27, wherein the cross-section of the first limit portion is L-shaped, T-shaped, P-shaped, or gourd hole-shaped.

31. The connector assembly according to claim 27, wherein the first limit portions are symmetrically arranged on two sides of an end of the first insulating body, and the second limit portions are symmetrically arranged on two sides of an end of the second insulating body.

32. The connector assembly according to claim 27, wherein the first insulating body comprises an insulating block and an insulating tongue plate, wherein the first limit portion and the insulating tongue plate are arranged at two ends of the insulating block respectively; and
the plurality of interface terminals comprise a plurality of first terminals and a plurality of second terminals, wherein the first terminal comprises a first mating portion extending in a third direction, and the first mating portion is arranged on a first surface of the insulating tongue plate; the second terminal comprises a second mating portion extending in the third direction, and the second mating portion is arranged on a second surface of the insulating tongue plate.

33. The connector assembly according to claim 32, wherein the interface connector further comprises a shielding member, the shielding member is arranged inside the first insulating body, and the shielding member is located between the first surface and the second surface.

34. The connector assembly according to claim 27, further comprising a circuit board, wherein the circuit board is provided with a plurality of connecting portions, and the plurality of connecting portions are connected to the plurality of adapter terminals in one-to-one correspondence.

35. An electronic device, comprising the connector assembly according to claim 25, and further comprising a shell, wherein the shell is provided with a first installation surface and a second installation surface, and the first installation surface and the second installation surface are at a preset distance; and
the interface connector is arranged on the first installation surface, and the adapter connector is arranged on the second installation surface.
